(19) United States
(12) Patent Application Publication
(10) Pub. No.: US 2025/0061361 A1
(43) Pub. Date: Feb. 20, 2025

(54) APPARATUS AND METHOD FOR MAGIC STATE DISTILLATION CIRCUIT IN LOGICAL QUBIT QUANTUM SYSTEM

(71) Applicant: ELECTRONICS AND TELECOMMUNICATIONS RESEARCH INSTITUTE, Daejeon (KR)

(72) Inventors: Soo-Cheol OH, Daejeon (KR); Young-Chul KIM, Daejeon (KR); Chei-Yol KIM, Daejeon (KR); Jin-Ho ON, Daejeon (KR); Sang-Min LEE, Daejeon (KR); Eun-Young CHO, Daejeon (KR); Ki-Sung JIN, Daejeon (KR); Gyu-Il CHA, Daejeon (KR)

(73) Assignee: ELECTRONICS AND TELECOMMUNICATIONS RESEARCH INSTITUTE, Daejeon (KR)

(21) Appl. No.: 18/802,087

(22) Filed: Aug. 13, 2024

(30) Foreign Application Priority Data
Aug. 14, 2023 (KR) 10-2023-0106371
Aug. 9, 2024 (KR) 10-2024-0106761

(51) Int. Cl. G06N 10/20

(52) U.S. Cl. CPC G06N 10/20

(57) ABSTRACT

Disclosed herein is an apparatus and method for executing a magic state distillation circuit in a logical qubit quantum system. The apparatus outputs a distilled magic state |Y>_{L} by executing a magic state |Y>_{L} distillation circuit in which multiple multi-target CNOT operations are performed in parallel and outputs a distilled magic state |A>_{L} by executing a magic state |A>_{L} distillation circuit in which multiple multi-target CNOT operations are performed in parallel. The magic state |Y>_{L} distillation circuit is configured with three code blocks, code blocks 1 and 2 being configured with multiple multi-target CNOT operations and code block 3 being configured with S_{L} operations and measurement operations, and the magic state |A>_{L} distillation circuit is configured with three code blocks, code blocks 1 and 2 being configured with multiple multi-target CNOT operations and code block 3 being configured with T_{L}⁺ operations and measurement operations.

### CROSS REFERENCE TO RELATED APPLICATIONS

This application claims the benefit of Korean Patent Applications No. 10-2023-0106371, filed Aug. 14, 2023, and No. 10-2024-0106761, filed Aug. 9, 2024, which are hereby incorporated by reference in their entireties into this application.

### BACKGROUND OF THE INVENTION

### 1. Technical Field

The present disclosure relates generally to quantum computing technology, and more particularly to technology for executing a magic state distillation circuit in a logical qubit quantum system.

### 2. Description of the Related Art

A quantum computer is a computer that processes data using quantum mechanical phenomena such as entanglement, superposition, and the like. Quantum computers are regarded as next-generation computers that can replace semiconductor computers. However, technology research related to quantum computers has fallen short of realizing quantum computers.

Quantum computers are being actively researched by various companies. The recent quantum computers are in the early stages of development at the level of supporting qubits with about 50 information errors and have not been put to practical use.

A quantum computer using logical qubits based on surface codes requires a magic state in order to perform logical S and T operations. A magic state refers to a specific quantum state with a very low error rate and may be generated by executing a magic state distillation circuit. Existing magic state distillation circuits are configured with complex quantum operations. Therefore, it is very important to execute the circuits while minimizing the execution time and the number of logical qubits.

Meanwhile, U.S. Pat. No. 11,405,056, titled “Magic state distillation using inner and outer error correcting codes” discloses a method using inner and outer error correction and stabilizer measurement in a method of distilling magic states using a [n, k, d] block code.

### SUMMARY OF THE INVENTION

An object of the present disclosure is to reduce the time required to execute an operation included in a magic state distillation circuit.

Another object of the present disclosure is to reduce the number of logical qubits required for an operation included in a magic state distillation circuit.

In order to accomplish the above objects, an apparatus for executing a magic state distillation circuit in a logical qubit quantum system according to an embodiment of the present disclosure includes one or more processors and memory for storing at least one program executed by the one or more processors. The at least one program outputs a distilled magic state |Y>_{L} by executing a magic state |Y>_{L} distillation circuit in which a plurality of multi-target CNOT operations are performed in parallel and outputs a distilled magic state |A>_{L} by executing a magic state |A>_{L} distillation circuit in which a plurality of multi-target CNOT operations are performed in parallel. The magic state |Y>_{L} distillation circuit is configured with three code blocks, code blocks 1 and 2 are configured with a plurality of multi-target CNOT operations, and code block 3 is configured with S_{L} operations and measurement operations. The magic state |A>_{L} distillation circuit is configured with three code blocks, code blocks 1 and 2 are configured with a plurality of multi-target CNOT operations, and code block 3 is configured with T_{L}⁺ operations and measurement operations.

Here, eight data logical qubits may be used in the magic state |Y>_{L} distillation circuit, three of the eight data logical qubits may be used as control data logical qubits of the multi-target CNOT operations, four of the eight data logical qubits may be used as target data logical qubits of the multi-target CNOT operations, and one of the eight data logical qubits may be used as an output data logical qubit for outputting a distilled magic qubit |Y>_{L}.

Here, a logical qubit layout corresponding to the magic state |Y>_{L} distillation circuit may be configured such that the eight data logical qubits are arranged and nine ancilla logical qubits are additionally arranged using lattice surgery in order to connect the eight data logical qubits.

Here, the three control data logical qubits, among the data logical qubits, may be arranged one by one at the outer edges of the logical qubit layout, the four target data logical qubits, among the data logical qubits, may be arranged in the center of the logical qubit layout, and the ancilla logical qubits may be arranged to connect the control data logical qubits with the target data logical qubits.

Here, the at least one program may repeat an operation of generating a merged logical qubit by selecting logical qubits to constitute the merged logical qubit in a logical qubit layout corresponding to the magic state |Y>_{L} distillation circuit and an operation of splitting the generated merged logical qubit, and may then inject a magic state |Y>_{LH} into seven ancilla logical qubits.

Here, the at least one program may generate seven merged logical qubits by merging the seven ancilla logical qubits into which the magic state |Y>_{LH} is injected with adjacent data logical qubits and measure the seven merged logical qubits in the X-basis, thereby outputting a distilled magic qubit |Y>_{L}.

Here, the at least one program may inject a magic state |Y>_{L1}, corresponding to the distilled magic qubit |Y>_{L}, from seven first magic state |Y>_{L1} distillation circuits, which output the distilled magic qubit |Y>_{L}, into seven ancilla logical qubits of a second magic state |Y>_{L2} distillation circuit for outputting a second distilled magic qubit |Y>_{L2}, thereby outputting the second distilled magic qubit |Y>_{L2}.

Here, the logical qubit layout of the second magic state |Y>_{L2} distillation circuit may be configured such that output data logical qubits of seven logical qubit layouts corresponding to the seven first magic state |Y>_{L1} distillation circuits are connected with the seven ancilla logical qubits of the second magic state |Y>_{L2} distillation circuit.

Here, 16 data logical qubits may be used in the magic state |A>_{L} distillation circuit, four of the 16 data logical qubits may be used as control data logical qubits of the multi-target CNOT operations, 11 of the 16 data logical qubits may be used as target data logical qubits of the multi-target CNOT operations, and one of the 16 data logical qubits may be used as an output data logical qubit for outputting a distilled magic qubit |A>_{L}.

Here, a logical qubit layout corresponding to the magic state |A>_{L} distillation circuit may be configured such that the 16 data logical qubits are arranged and 30 ancilla logical qubits are additionally arranged using lattice surgery in order to connect the 16 data logical qubits.

Here, the four control data logical qubits, among the data logical qubits, may be arranged one by one at the outer edges of the logical qubit layout, the 11 target data logical qubits, among the data logical qubits, may be arranged in the center of the logical qubit layout, and the ancilla logical qubits may be arranged to connect the control data logical qubits with the target data logical qubits.

Here, at least two of the ancilla logical qubits may be connected with the control data logical qubit and the target data logical qubit.

Here, the at least one program may repeat an operation of generating a merged logical qubit by selecting logical qubits to constitute the merged logical qubit in a logical qubit layout corresponding to the magic state |A>_{L} distillation circuit and an operation of splitting the generated merged logical qubit, inject a magic state |A>_{LH} into 15 ancilla logical qubits, and inject a magic state |Y>_{LH} into 15 additional ancilla logical qubits.

Here, the at least one program may generate 15 merged logical qubits by merging the 15 ancilla logical qubits into which the magic state |A>_{LH} is injected with adjacent data logical qubits, expand the 15 merged logical qubits by additionally merging the same with the adjacent 15 ancilla logical qubits into which the magic state |Y>_{LH} is injected, and measure the expanded 15 merged logical qubits in the X-basis, thereby outputting a distilled magic qubit |A>_{L}.

Here, the at least one program may obtain joint measurement values of the 15 merged logical qubits, may expand the merged logical qubit by additionally merging the same with the adjacent ancilla logical qubit, into which the magic state |Y>_{LH} is injected, when the joint measurement value of the merged logical qubit is −1, and may not expand the merged logical qubit when the joint measurement value thereof is +1.

Here, the at least one program may inject a first magic state |A>_{L1}, corresponding to the distilled magic qubit |A>_{L}, and a first magic state |Y>_{L1} from 15 first magic state |A>_{L1} distillation circuits, which output the distilled magic qubit |A>_{L}, into 30 ancilla logical qubits of a second magic state |A>_{L2} distillation circuit for outputting a second distilled magic qubit |A>_{L2}, thereby outputting a second distilled magic state |A>_{L2}.

Here, the at least one program may select an output data logical qubit and 16 logical qubits closest to the output data logical qubit in the first magic state |A>_{L1} distillation circuit, thereby executing a similar first magic state |Y>_{L1} distillation circuit for generating the first magic state |Y>_{L1}.

Here, the at least one program may move the magic state |Y>_{L1} generated in the output data logical qubit of the similar first magic state |Y>_{L1} distillation circuit to an adjacent logical qubit, thereby configuring the adjacent logical qubit as a magic state |Y>_{L1} output data logical qubit.

Here, the logical qubit layout of the second magic state |A>_{L2} distillation circuit may be configured such that first magic state |A>_{L1} output data logical qubits and first magic state |Y>_{L1} output data logical qubits of 15 logical qubit layouts corresponding to the 15 first magic state |A>_{L1} distillation circuits are connected with the 30 ancilla logical qubits of the second magic state |A>_{L2} distillation circuit.

Also, in order to accomplish the above objects, a method for executing a magic state distillation circuit in a logical qubit quantum system, performed by an apparatus for executing the magic state distillation circuit in the logical qubit quantum system, according to an embodiment of the present disclosure includes outputting a distilled magic state |Y>_{L} by executing a magic state |Y>_{L} distillation circuit in which a plurality of multi-target CNOT operations are performed in parallel and outputting a distilled magic state |A>_{L} by executing a magic state |A>_{L} distillation circuit in which a plurality of multi-target CNOT operations are performed in parallel. The magic state |Y>_{L} distillation circuit is configured with three code blocks, code blocks 1 and 2 are configured with a plurality of multi-target CNOT operations, and code block 3 is configured with S_{L} operations and measurement operations. The magic state |A>_{L} distillation circuit is configured with three code blocks, code blocks 1 and 2 are configured with a plurality of multi-target CNOT operations, and code block 3 is configured with T_{L}⁺ operations and measurement operations.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a circuit diagram illustrating a magic state distillation circuit optimized to generate a magic state |Y>_{L} according to an embodiment of the present disclosure;

FIG. 2 is a circuit diagram illustrating a magic state distillation circuit optimized to generate a magic state |A>_{L} according to an embodiment of the present disclosure;

FIG. 3 is a layout diagram illustrating the layout of logical qubits for distilling a magic state |Y>_{L1} according to an embodiment of the present disclosure;

FIGS. 4 to 14 are views illustrating in detail an example of a process of distilling a magic state |Y>_{L1} using the logical qubit layout diagram illustrated in FIG. 3;

FIG. 15 is a layout diagram illustrating the layout of logical qubits for distilling a magic state |A>_{L1} according to an embodiment of the present disclosure;

FIGS. 16 to 27 are views illustrating in detail an example of a process of distilling a magic state |A>_{L1} using the logical qubit layout diagram illustrated in FIG. 15;

FIG. 28 is a view illustrating the logical qubit layout of a second magic state |Y>_{L2} distillation circuit for generating a magic state |Y>_{L2} by further performing second distillation on first distilled |Y>_{L1} according to an embodiment of the present disclosure;

FIG. 29 is a view illustrating the logical qubit layout of a second magic state |A>_{L2} distillation circuit for generating a magic state |A>_{L2} by further performing second distillation on first distilled |A>_{L1} according to an embodiment of the present disclosure;

FIGS. 30 to 32 are views illustrating in detail an example of a process of distilling a magic state |A>_{L2} using the logical qubit layout diagram of the second magic state distillation circuit illustrated in FIG. 29;

FIG. 33 is a flowchart illustrating a method for executing a magic state distillation circuit in a logical qubit quantum system according to an embodiment of the present disclosure;

FIG. 34 is a flowchart illustrating an example of the step of performing distillation of a magic state |Y>_{L} illustrated in FIG. 33;

FIG. 35 is a flowchart illustrating an example of the step of performing distillation of a magic state |A>_{L} illustrated in FIG. 33; and

FIG. 36 is a view illustrating a computer system according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

Throughout this specification, the terms “comprises” and/or “comprising” and “includes” and/or “including” specify the presence of stated elements but do not preclude the presence or addition of one or more other elements unless otherwise specified.

Hereinafter, a preferred embodiment of the present disclosure will be described in detail with reference to the accompanying drawings.

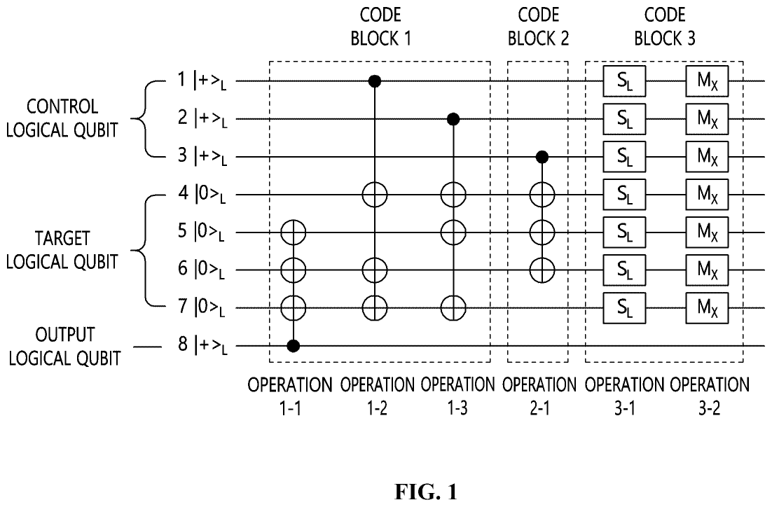

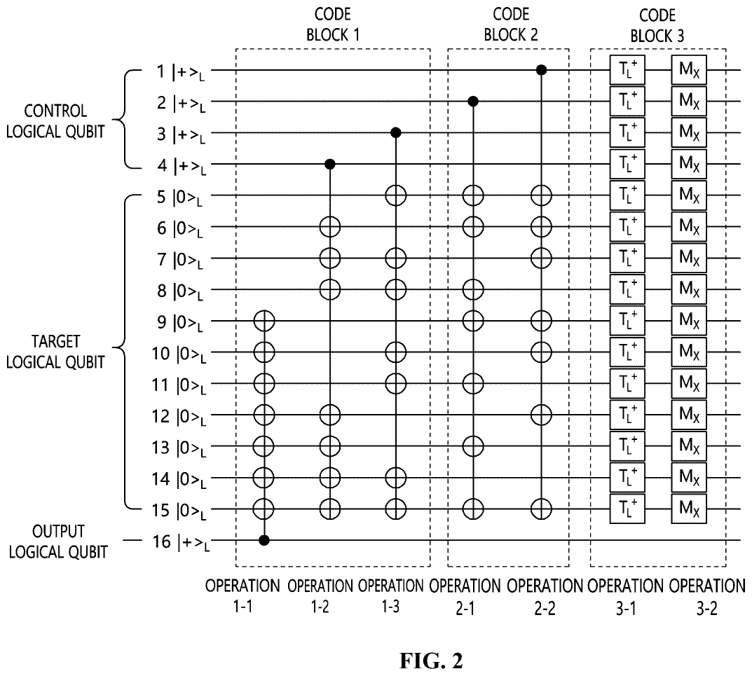

FIG. 1 is a circuit diagram illustrating a magic state distillation circuit optimized to generate a magic state |Y>_{L} according to an embodiment of the present disclosure. FIG. 2 is a circuit diagram illustrating a magic state distillation circuit optimized to generate a magic state |A>_{L} according to an embodiment of the present disclosure.

|Y>_{L} is a magic state required for a logical S operation, and |A>_{L} is a magic state required for a logical T operation. A magic state refers to a specific quantum state with a very low error rate, and may be generated by executing a magic state distillation circuit.

Referring to FIG. 1, it can be seen that a magic state |Y>_{L} distillation circuit is configured with three code blocks and uses eight logical qubits, which are indicated by the numbers 1 to 8.

It can be seen that code blocks 1 and 2 of the magic state |Y>_{L} distillation circuit are configured with a plurality of multi-target CNOT operations.

It can be seen that three CNOT operations are performed in parallel in each of operations 1-1, 1-2, 1-3, and 2-1 of the magic state |Y>_{L} distillation circuit, whereby the multi-target CNOT operation is performed.

It can be seen that code block 3 of the magic state |Y>_{L} distillation circuit is configured with seven S_{L} operations and measurement operations.

Logical qubits 1 to 3 of the magic state |Y>_{L} distillation circuit may be used as control data logical qubits of the multi-target CNOT operations.

Logical qubits 4 to 7 of the magic state |Y>_{L} distillation circuit may be used as target data logical qubits of the multi-target CNOT operations.

Logical qubit 8 of the magic state |Y>_{L} distillation circuit is used as an output data logical qubit for outputting a distilled magic qubit |Y>_{L}, and may also be used as a control data logical qubit of operation 1-1. In the present disclosure, the three multi-target CNOT operations in code block 1 may be performed in parallel.

Referring to FIG. 2, it can be seen that a magic state |A>_{L} distillation circuit is configured with three code blocks and uses 16 logical qubits, which are indicated by the numbers 1 to 16.

It can be seen that code blocks 1 and 2 of the magic state |A>_{L} distillation circuit are configured with a plurality of multi-target CNOT operations.

It can be seen that seven CNOT operations are performed in parallel in each of operations 1-1, 1-2, 1-3, 2-1, and 2-2 of the magic state |A>_{L} distillation circuit, whereby the multi-target CNOT operation is performed.

It can be seen that code block 3 of the magic state |A>_{L} distillation circuit is configured with 15 T_{L}⁺ operations and measurement operations.

Logical qubits 1 to 4 of the magic state |A>_{L} distillation circuit may be used as control data logical qubits of the multi-target CNOT operations.

Logical qubits 5 to 15 of the magic state |A>_{L} distillation circuit may be used as target data logical qubits of the multi-target CNOT operations.

Logical qubit 16 of the magic state |A>_{L} distillation circuit is used as an output data logical qubit for outputting a distilled magic qubit |A>_{L}, and may also be used as a control data logical qubit of operation 1-1. In the present disclosure, the three multi-target CNOT operations included in code block 1 may be performed in parallel, and the two multi-target CNOT operations included in code block 2 may be performed in parallel.

The present disclosure enables a plurality of multi-target CNOT operations to be simultaneously executed, thereby reducing the time required for execution. Also, the present disclosure allows ancilla logical qubits required for multi-target CNOT operations and ancilla logical qubits required for execution of S_{L} and T_{L}⁺ operations to be shared with each other, thereby reducing the number of required logical qubits.

In the present disclosure, the magic state |Y>_{L} may be subdivided into three states: |Y>_{LH}, |Y>_{L1}, and |Y>_{L2}.

The magic state |Y>_{LH} indicates a quantum state with a high error rate before execution of a magic state distillation circuit, and may be generated by performing state injection.

The magic state |Y>_{L1} may indicate a magic state obtained whereby a magic state distillation circuit is executed once.

The magic state |Y>_{L2} may indicate a magic state in which an error rate is further lowered by executing a magic state distillation circuit twice.

Also, in the present disclosure, the magic state |A>_{L} may be subdivided into three states: |A>_{LH}, |A>_{L1}, and |A>_{L2}.

The magic state |A>_{LH} indicates a quantum state with a high error rate before execution of a magic state distillation circuit, and may be generated by performing state injection.

The magic state |A>_{L1} may indicate a magic state obtained whereby a magic state distillation circuit is executed once.

The magic state |A>_{L2} may indicate a magic state in which an error rate is further lowered by executing a magic state distillation circuit twice.

FIG. 3 is a layout diagram illustrating the layout of logical qubits for distilling a magic state |Y>_{L1} according to an embodiment of the present disclosure.

Referring to FIG. 3, it can be seen that the layout of logical qubits for distilling a magic state |Y>_{L1} is configured with a total of 17 logical qubits and that data logical qubits 1 to 8 correspond to the logical qubit numbers illustrated in FIG. 1.

Ancilla logical qubits 9 to 17 may be supplementarily used in order to execute the circuit of FIG. 1 using lattice surgery.

When execution of the magic state distillation process is completed, the magic state |Y>_{L1} may be stored in logical qubit 8.

The data logical qubits may be categorized into control data logical qubits and target data logical qubits.

The ancilla logical qubits may be categorized into ancilla logical qubits for CNOT, ancilla logical qubits for S, and ancilla logical qubits for CNOT+S.

The ancilla logical qubits for CNOT+S may be used by being shared between CNOT operations and S_{L} operations.

The logical qubit layout illustrated in FIG. 3 may be configured such that, first, the ancilla logical qubits for CNOT are arranged to connect the control data logical qubits with the target data logical qubits.

The ancilla logical qubits for S may be arranged in the vicinity of the seven data logical qubits.

Also, the ancilla logical qubits for CNOT and the ancilla logical qubits for S may be arranged to be shared with each other.

The three control data logical qubits, among the data logical qubits, may be arranged one by one at the outer edges of the logical qubit layout, the four target data logical qubits, among the data logical qubits, may be arranged in the center of the logical qubit layout, and the ancilla logical qubits for CNOT may be arranged to connect the control data logical qubits with the target data logical qubits.

A detailed description of the layout based on the corresponding principle is as follows.

Logical qubits 1 to 3, which are the control data logical qubits, may be arranged at the edges of the logical qubit layout.

Logical qubits 4 to 7, which are the target data logical qubits, may be arranged lengthwise in the center.

Logical qubits 10 to 17, which are the ancilla logical qubits for CNOT, are used for the multi-target CNOT operations present in code blocks 1 and 2, and may be arranged on the right and left sides of the target data logical qubits in order to connect the control data logical qubits with the target data logical qubits.

Here, the ancilla logical qubits for CNOT should adjoin the control data logical qubits with an X boundary, and may adjoin the target data logical qubits with a Z boundary.

Logical qubits 9, 10, 12 to 15, and 17, which are the ancilla logical qubits for S, are used for the S_{L} operations present in code block 3, and each of these logical qubits is arranged for each of logical qubits 1 to 7, which are the data logical qubits, such that it is adjacent to the data logical qubit in one of the upward, downward, leftward, and rightward directions with respect thereto.

Accordingly, a total of seven ancilla logical qubits for S may be arranged.

Here, because the ancilla logical qubits for CNOT are already arranged adjacent to the data logical qubits, the ancilla logical qubits for S may share the ancilla logical qubits for CNOT.

These are referred to as ancilla logical qubits for CNOT+S, and correspond to ancilla logical qubits 10, 12 to 15, and 17.

Ancilla logical qubit 9 may be arranged for only S_{L} operations. When the ancilla logical qubit for S is arranged, there is no need to match the X or Z boundary. This is because a task of matching the boundary with which logical qubits face each other is to be performed by rotating the logical qubit in the execution process.

Finally, it can be seen that, unlike the control data logical qubits, data logical qubit 8 is located at the bottom with respect to the target data logical qubits, rather than being arranged at the edge. This is due to the distinctiveness of operation 1-1 in which data logical qubit 8 is used for control.

Operation 1-1 may perform a combination of special inputs in which the state |+> is used as the control and the state |0> is used as the target.

Operation 1-1 directly connects the control data logical qubit with the target data logical qubit without using any ancilla logical qubit for CNOT, thereby performing the multi-target CNOT operation.

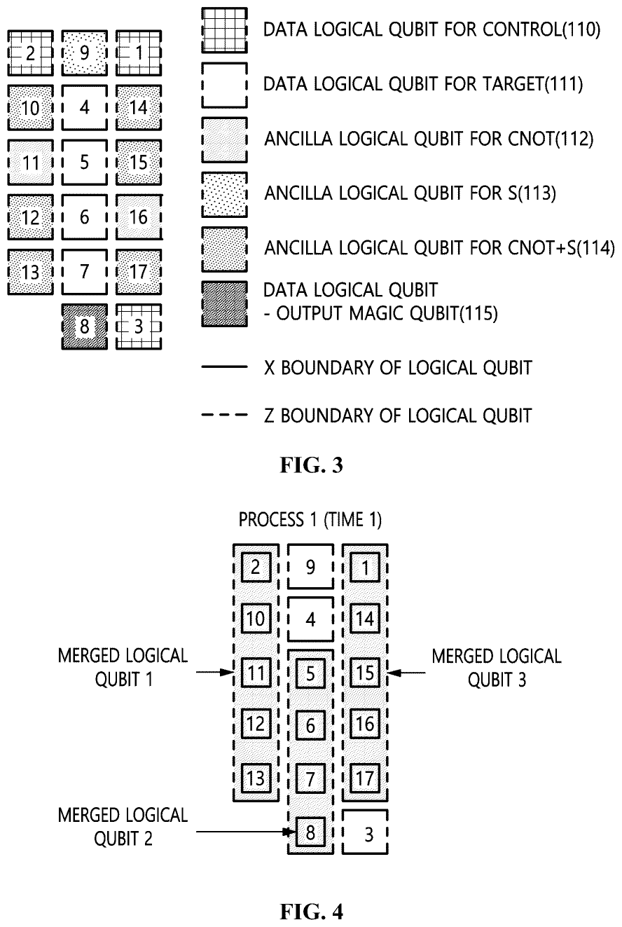

FIGS. 4 to 14 are views illustrating in detail an example of a process of distilling a magic state |Y>_{L1} using the logical qubit layout diagram illustrated in FIG. 3.

Code block 1 of FIG. 1 may be performed through the processes of FIGS. 4 to 7.

Code block 2 of FIG. 1 may be performed through the processes of FIGS. 8 to 11.

Code block 3 of FIG. 1 may be performed through the processes of FIGS. 12 to 14.

In the process of distilling the magic state |Y>_{L1}, the operation of generating a merged logical qubit by selecting logical qubits to constitute the merged logical qubit in the logical qubit layout corresponding to a magic state |Y>_{L1} distillation circuit and the operation of splitting the generated merged logical qubit are repeated, after which a magic state |Y>_{LH} may be injected into seven ancilla logical qubits.

In the process of distilling the magic state |Y>_{L1}, seven merged logical qubits are generated by merging the seven ancilla logical qubits into which the magic state |Y>_{LH} is injected with adjacent data logical qubits, and the seven merged logical qubits are measured in the X-basis, whereby a distilled magic qubit |Y>_{L1} may be output.

Referring to FIG. 4, each of merged logical qubits 1 to 3 is initialized to the |+>_{L} state as the first process of generating a magic state |Y>_{L1}.

Merged logical qubits 1 to 3 indicate logical qubits included in the operation of the current process.

Merged logical qubit 1 is a single logical qubit having a size that includes all of logical qubits 2, 10, 11, 12, and 13, and may generate the |+>_{L} state by performing a |+>_{L} initialization process of the logical qubit.

Merged logical qubits 2 and 3 may also generate the |+>_{L} state by performing the same process as merged logical qubit 1.

Merged logical qubit 2 is a single logical qubit including logical qubits 5, 6, 7, and 8.

Merged logical qubit 3 is a single logical qubit including logical qubits 1, 14, 15, 16, and 17.

When the three merged logical qubits are generated, logical qubit 4 may be initialized to |0>_{L}.

Referring to FIG. 4, the rule for selecting the logical qubits to constitute a merged logical qubit is as follows. A single multi-target CNOT operation is selected, and ancilla logical qubits for CNOT that are required to connect the control data logical qubit of the corresponding operation with the multiple target data logical qubits of the corresponding operation may be additionally selected. A detailed description thereof is as follows.

Merged logical qubit 1 may be generated by including logical qubits 2 and 10 to 13 for operation 1-3.

First, logical qubit 2, which is a control data logical qubit, may be selected. Then, ancilla logical qubits 10, 11, and 13 on the left side of logical qubits 4, 5, and 7 may be selected to connect logical qubit 2, which is the control data logical qubit, with logical quits 4, 5, and 7, which are the target data logical qubits. Finally, because ancilla logical qubit 12 is in the passage connecting ancilla logical qubits 11 and 13, it may be selected together.

Merged logical qubit 3 may be generated by including logical qubits 1 and 14 to 17 for operation 1-2.

First, logical qubit 1, which is a control data logical qubit, may be selected. Then, ancilla logical qubits 14, 16, and 17 on the right side of logical qubits 4, 6, and 7 may be selected to connect logical qubit 1, which is the control data logical qubit, with logical qubits 4, 6, and 7, which are the target data logical qubits. Finally, because ancilla logical qubit 15 is in the passage connecting ancilla logical qubits 14 and 16, it may be selected together.

Merged logical qubit 2 may be generated by including logical qubits 5, 6, 7, and 8 for operation 1-1. As described in the layout of FIG. 3, operation 1-1 may be performed by directly connecting the control data logical qubit (logical qubit 8) with the target data logical qubits (logical qubits 5 to 7) without using any ancilla logical qubit for CNOT.

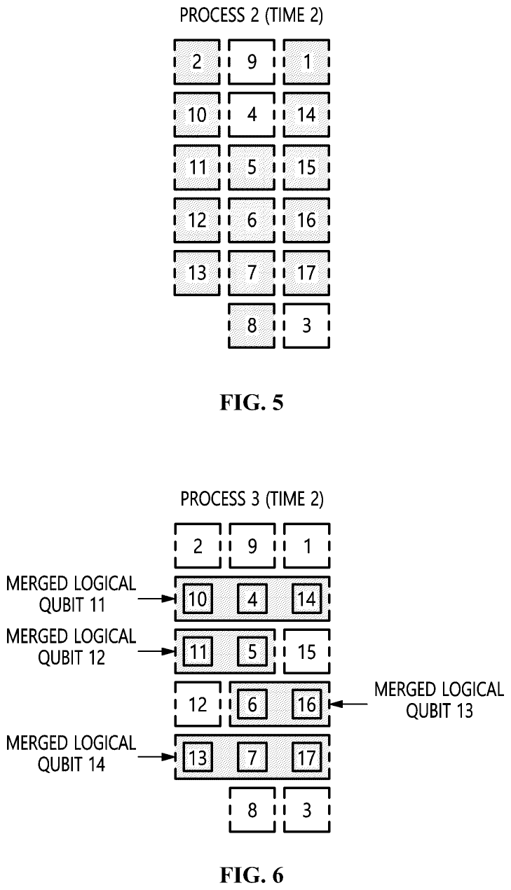

Referring to FIG. 5, an X-boundary split operation is performed, whereby each of merged logical qubits 1 to 3 may be split into logical qubits having the original size.

Merged logical qubit 1 may be split into logical qubits 2, 10, 11, 12, and 13 by the X-boundary split operation performed thereon.

Merged logical qubit 2 may be split into logical qubits 5, 6, 7, and 8 by the X-boundary split operation performed thereon.

Merged logical qubit 3 may be split into logical qubits 1, 14, 15, 16, and 17 by the X-boundary split operation performed thereon.

Referring to FIG. 6, a Z-boundary merge operation is performed, whereby four merged logical qubits 11 to 14 may be generated.

Merged logical qubit 11 may be generated by performing Z-boundary merging on logical qubits 10, 4, and 14.

Merged logical qubit 12 may be generated by performing Z-boundary merging on logical qubits 11 and 5.

Merged logical qubit 13 may be generated by performing Z-boundary merging on logical qubits 6 and 16.

Merged logical qubit 14 may be generated by performing Z-boundary merging on logical qubits 13, 7, and 17.

In FIG. 6, the rule for selecting the logical qubits to constitute a merged logical qubit is as follows.

In code block 1, the multi-target CNOT operations that use the same target data logical qubit are selected, and ancilla logical qubits for CNOT that are connected with the control data logical qubit of the corresponding operation may be selected. A detailed description thereof is as follows.

Merged logical qubit 11 selects logical qubit 4, which is a target data logical qubit, and finds operation 1-2 and operation 1-3 that uses logical qubit 4 as a target. Ancilla logical qubit 14 that connects logical qubit 1, which is the control data logical qubit of operation 1-2, with logical qubit 4 may be selected. Then, ancilla logical qubit 10 that connects logical qubit 2, which is the control data logical qubit of operation 1-3, with logical qubit 4 may be selected.

Merged logical qubit 12 selects logical qubit 5, which is a target data logical qubit, and finds operation 1-1 and operation 1-3 that use logical qubit 5 as a target. Because operation 1-1 uses no ancilla logical qubit, no additional logical qubit is selected. Ancilla logical qubit 11 that connects logical qubit 2, which is the control data logical qubit of operation 1-3, with logical qubit 5 may be selected.

Merged logical qubit 13 selects logical qubit 6, which is a target data logical qubit, and finds operation 1-1 and operation 1-2 that use logical qubit 6 as a target. Because operation 1-1 uses no ancilla logical qubit, no additional logical qubit is selected. Ancilla logical qubit 16 that connects logical qubit 1, which is the control data logical qubit of operation 1-2, with logical qubit 6 may be selected.

Merged logical qubit 14 selects logical qubit 7, which is a target data logical qubit, and finds operation 1-1, operation 1-2, and operation 1-3 that use logical qubit 7 as a target. Because operation 1-1 uses no ancilla logical qubit, no additional logical qubit is selected. Ancilla logical qubit 17 that connects logical qubit 1, which is the control data logical qubit of operation 1-2, with logical qubit 7 may be selected. Then, ancilla logical qubit 13 that connects logical qubit 2, which is the control data logical qubit of operation 1-3, with logical qubit 7, which is the target data logical qubit, may be selected.

The processes of FIG. 5 and FIG. 6 may be performed in parallel.

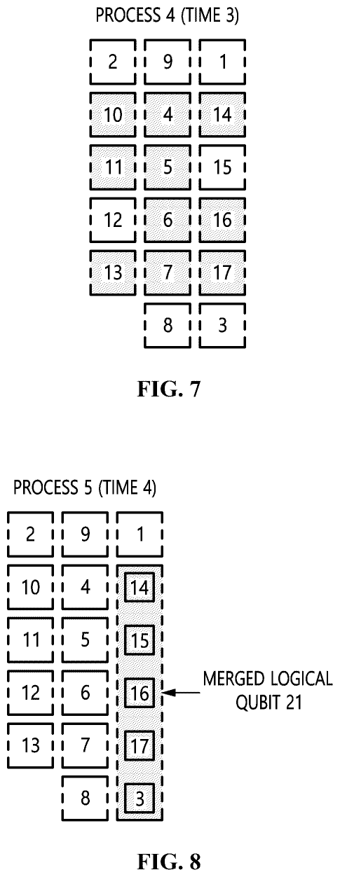

Referring to FIG. 7, it can be seen that each of merged logical qubits 11 to 14 is split into logical qubits having the original size by the Z-boundary split operation performed thereon.

Merged logical qubit 11 may be split into logical qubits 10, 4, and 14 by Z-boundary splitting.

Merged logical qubit 12 may be split into logical qubits 11 and 5 by Z-boundary splitting.

Merged logical qubit 13 may be split into logical qubits 6 and 16 by Z-boundary splitting.

Merged logical qubit 14 may be split into logical qubits 13, 7, and 17 by Z-boundary splitting.

Referring to FIG. 8, merged logical qubit 21 may be initialized to the |+>_{L} state.

Merged logical qubit 21 is a single logical qubit having a size that includes all of logical qubits 14, 15, 16, 17, and 3.

Merged logical qubit 21 may generate the |+>_{L} state by performing a |+>_{L} initialization process of the logical qubit.

The method of selecting the logical qubits constituting the merged logical qubit in FIG. 8 may be the same method as described in FIG. 4.

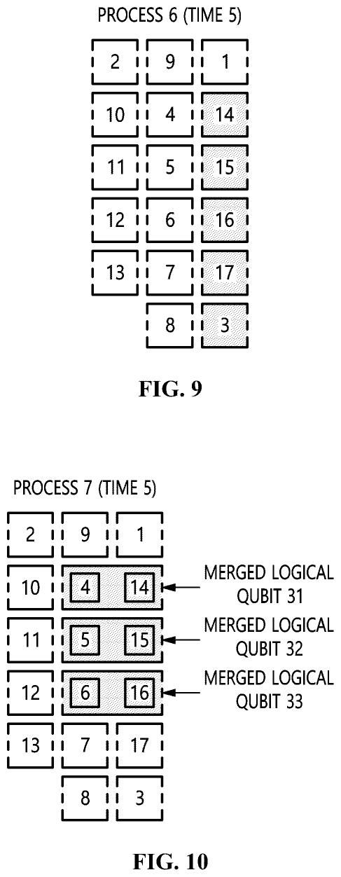

Referring to FIG. 9, it can be seen that merged logical qubit 21 is split into logical qubits having the original size by the X-boundary split operation performed thereon. Merged logical qubit 21 may be split into logical qubits 14, 15, 16, 17, and 3.

Referring to FIG. 10, it can be seen that merged logical qubits 31 to 33 are generated by performing a Z-boundary merge operation.

Merged logical qubit 31 may be generated by performing Z-boundary merging on logical qubits 4 and 14.

Merged logical qubit 32 may be generated by performing Z-boundary merging on logical qubits 5 and 15.

Merged logical qubit 33 may be generated by performing Z-boundary merging on logical qubits 6 and 16.

The method of selecting the logical qubits constituting the merged logical qubit in FIG. 10 may be the same method as described in FIG. 6.

The processes of FIG. 9 and FIG. 10 may be performed in parallel.

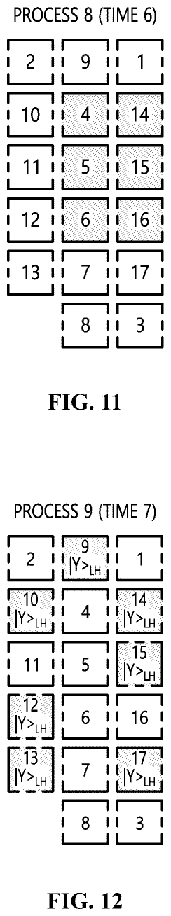

Referring to FIG. 11, each of merged logical qubits 31 to 33 may be split into logical qubits having the original size by the Z-boundary split operation performed thereon.

Merged logical qubit 31 may be split into logical qubits 4 and 14 by Z-boundary splitting performed thereon.

Merged logical qubit 32 may be split into logical qubits 5 and 15 by Z-boundary splitting performed thereon.

Merged logical qubit 33 may be split into logical qubits 6 and 16 by Z-boundary splitting performed thereon.

Referring to FIG. 12, it can be seen that a process in which seven undistilled |Y>_{LH} states having a high error rate are generated through state injection into logical qubits in order to perform the seven S_{L} operations present in code block 3 of FIG. 1 is illustrated.

Here, state injection into logical qubits 9, 10, 14, and 17 may be performed while maintaining the X and Z boundaries of the logical qubits.

Here, state injection into logical qubits 12, 13, and 15 may be performed in the form of a 90-degree rotation of the X and Z boundaries of the logical qubits.

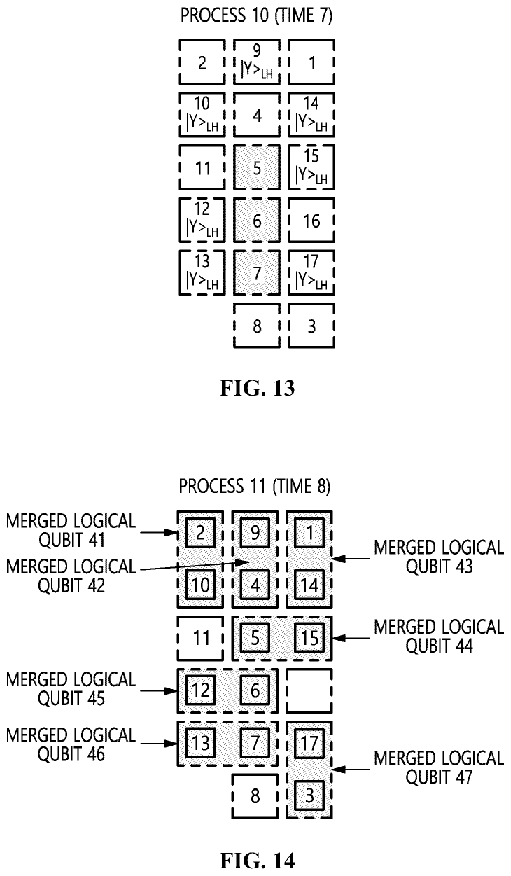

Referring to FIG. 13, the X and Z boundaries of logical qubits 5, 6, and 7 may be rotated by 90 degrees.

In FIGS. 12 and 13, the 90-degree rotation of the logical qubits is required for the following reason.

A data logical qubit and a |Y>_{LH} state use the X boundary to generate a merged logical qubit. To this end, it is required to match the X boundaries of the ancilla logical qubit for S_{L} and the data logical qubit, so the logical qubits may be rotated by 90 degrees. Here, ancilla logical qubits 12, 13, and 15 and data logical qubits 5, 6, and 7 may be rotated by 90 degrees.

The processes of FIG. 12 and FIG. 13 may be performed in parallel.

Referring to FIG. 14, it can be seen that merged logical qubits 41 to 47 are generated by performing X-boundary merging of logical qubits 1 to 7 with adjacent logical qubits having the |Y>_{LH} state.

The combinations of the numbers of the logical qubits on which X-boundary merging is performed are as follows.

Merged logical qubit 41 may be generated by performing X-boundary merging on logical qubits 2 and 10.

Merged logical qubit 42 may be generated by performing X-boundary merging on logical qubits 9 and 4.

Merged logical qubit 43 may be generated by performing X-boundary merging on logical qubits 1 and 14.

Merged logical qubit 44 may be generated by performing X-boundary merging on logical qubits 5 and 15.

Merged logical qubit 45 may be generated by performing X-boundary merging on logical qubits 12 and 6.

Merged logical qubit 46 may be generated by performing X-boundary merging on logical qubits 13 and 7.

Merged logical qubit 47 may be generated by performing X-boundary merging on logical qubits 17 and 3.

Finally, when merged logical qubits 41 to 47 are measured in the X-basis, it can be seen that a distilled |Y>_{L1} state is generated in logical qubit 8.

In FIGS. 4 to 14, there are eleven execution processes, and these processes may be executed in chronological order. Here, processes 2 and 3 of FIG. 5 and FIG. 6 may be performed in parallel. Similarly, processes 6 and 7 of FIG. 9 and FIG. 10 may be performed in parallel, and processes 9 and 10 of FIG. 12 and FIG. 13 may also be performed in parallel.

When the time required for error syndrome measurement is defined as one unit of time, one unit of time may be used for each process. Therefore, the time taken to execute the magic state |Y>_{L1} distillation circuit may be 8.

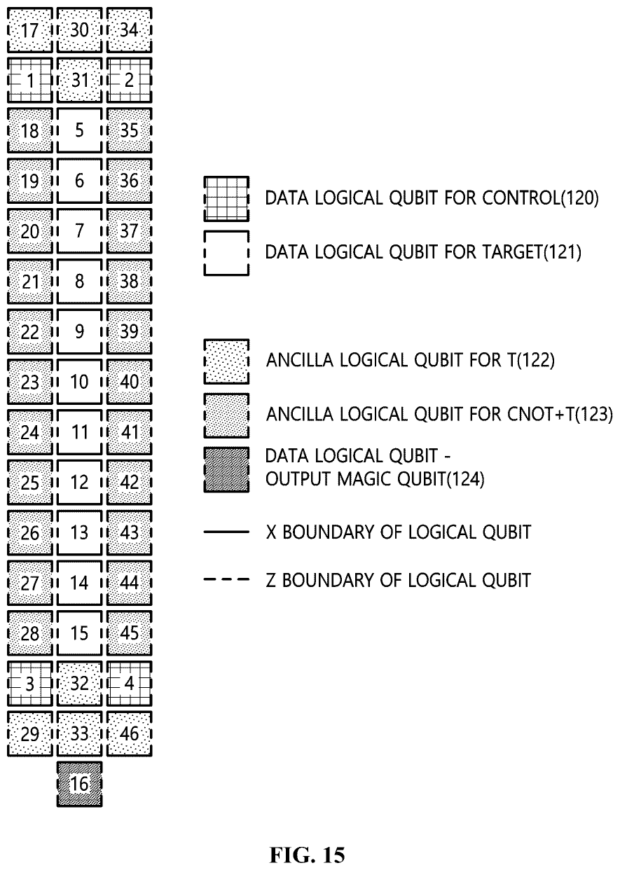

FIG. 15 is a layout diagram illustrating the layout of logical qubits for distilling a magic state |A>_{L1} according to an embodiment of the present disclosure.

Referring to FIG. 15, the layout is configured with a total of 46 logical qubits, and data logical qubits 1 to 16 may correspond to the logical qubit numbers illustrated in FIG. 2.

Ancilla logical qubits 17 to 46 may be supplementarily used to execute the circuit of FIG. 2 using lattice surgery. When execution of the magic state distillation circuit is completed, the magic state |A>_{L1} may be stored in logical qubit 16.

The rule for arranging logical qubits in FIG. 15 is the same as that used in FIG. 3, but has the difference that it uses more ancilla logical qubits for T.

The layout of FIG. 3 requires one ancilla logical qubit for S for each data logical qubit for an S_{L} operation, but the layout of FIG. 15 requires two ancilla logical qubits for T for each data logical qubit for a T_{L}⁺ operation.

Accordingly, more ancilla logical qubits for T are arranged in the layout diagram of FIG. 15, and all of ancilla logical qubits for CNOT may share the roles with the ancilla logical qubits for T.

The four control data logical qubits, among the data logical qubits, may be arranged one by one at the outer edges of the logical qubit layout, the 11 target data logical qubits, among the data logical qubits, may be arranged in the center of the logical qubit layout, and the ancilla logical qubits may be arranged to connect the control data logical qubits with the target data logical qubits.

Also, eight ancilla logical qubits for T may be additionally arranged in the vicinity of the four control data logical qubits (logical qubits 1 to 4).

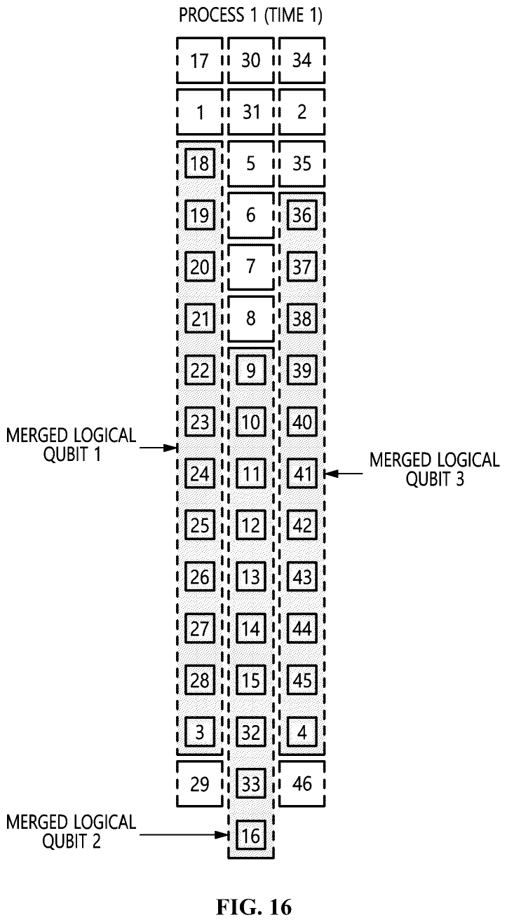

FIGS. 16 to 27 are views illustrating in detail an example of a process of distilling a magic state |A>_{L1} using the logical qubit layout diagram illustrated in FIG. 15.

Code block 1 of FIG. 2 may be performed through the processes of FIGS. 16 to 19.

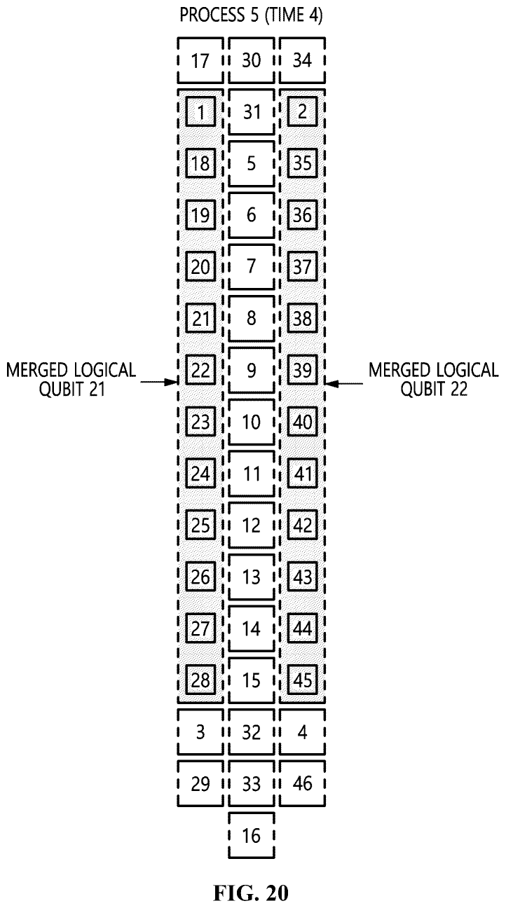

Code block 2 of FIG. 2 may be performed through the processes of FIGS. 20 to 23.

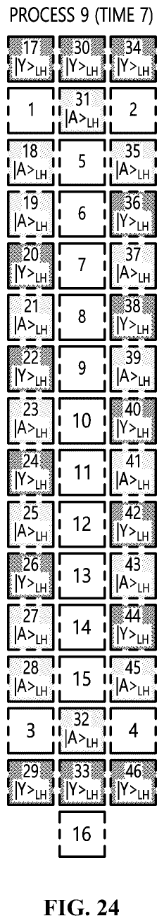

Code block 3 of FIG. 2 may be performed through the processes of FIGS. 24 to 27.

In the process of distilling a magic state |A>_{L1}, the operation of generating a merged logical qubit by selecting the logical qubits to constitute the merged logical qubit in the logical qubit layout corresponding to the magic state |A>_{L} distillation circuit and the operation of splitting the generated merged logical qubit are repeated, after which a magic state |A>_{LH} may be injected into 15 ancilla logical qubits and a magic state |Y>_{LH} may be injected into 15 additional ancilla logical qubits.

In the process of distilling the magic state |A>_{L1}, 15 merged logical qubits are generated by merging the 15 ancilla logical qubits into which the magic state |A>_{LH} is injected with adjacent data logical qubits, and the 15 merged logical qubits are expanded by being additionally merged with the adjacent 15 ancilla logical qubits into which the magic state |Y>_{LH} is injected and measured in the X-basis, whereby a distilled magic qubit |A>_{L1} may be output.

Referring to FIG. 16, each of merged logical qubits 1 to 3 may be initialized to the |+>_{L} state as the first process of generating a magic state |A>_{L1}.

Merged logical qubit 1 is a single logical qubit having a size that includes all of logical qubits 18 to 28 and 3, and may generate the |+>_{L} state by performing a |+>_{L} initialization process of the logical qubit.

Merged logical qubits 2 and 3 may also generate the |+>_{L} state by performing the same process as merged logical qubit 1.

Merged logical qubit 2 is a single logical qubit including logical qubits 9 to 16 and 32 to 33.

Merged logical qubit 3 is a single logical qubit including logical qubits 36 to 45 and 4.

When the three merged logical qubits are generated, each of logical qubits 5 to 8 may be initialized to |0>_{L}.

The method of selecting the logical qubits constituting the merged logical qubit in FIG. 16 may be the same method as described in FIG. 4.

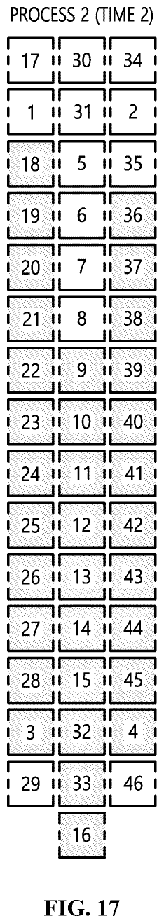

Referring to FIG. 17, each of merged logical qubits 1 to 3 may be split into logical qubits having the original size by the X-boundary split operation performed thereon.

Merged logical qubit 1 may be split into logical qubits 18 to 28 and 3 by X-boundary splitting performed thereon.

Merged logical qubit 2 may be split into logical qubits 9 to 16 and 32 to 33 by X-boundary splitting performed thereon.

Merged logical qubit 3 may be split into logical qubits 36 to 45 and 4 by X-boundary splitting performed thereon.

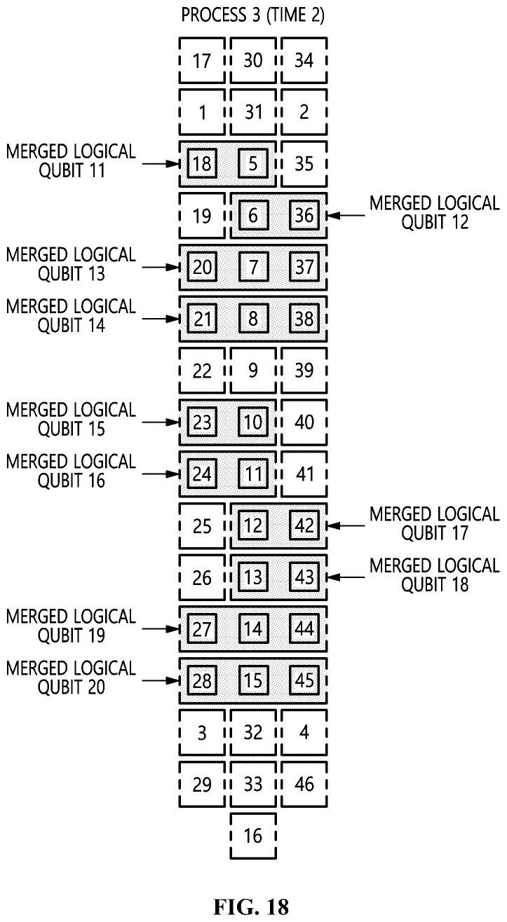

Referring to FIG. 18, it can be seen that merged logical qubits 11 to 20 are generated by performing a Z-boundary merge operation.

The method of selecting the logical qubits constituting the merged logical qubits in FIG. 18 is the same method as described in FIG. 6.

Merged logical qubit 11 may be generated by performing Z-boundary merging on logical qubit 18 and 5.

Merged logical qubit 12 may be generated by performing Z-boundary merging on logical qubits 6 and 36.

Merged logical qubit 13 may be generated by performing Z-boundary merging on logical qubits 20, 7, and 37.

Merged logical qubit 14 may be generated by performing Z-boundary merging on logical qubits 21, 8, and 38.

Merged logical qubit 15 may be generated by performing Z-boundary merging on logical qubit 23 and 10.

Merged logical qubit 16 may be generated by performing Z-boundary merging on logical qubits 24 and 11.

Merged logical qubit 17 may be generated by performing Z-boundary merging on logical qubits 12 and 42.

Merged logical qubit 18 may be generated by performing Z-boundary merging on logical qubits 13 and 43.

Merged logical qubit 19 may be generated by performing Z-boundary merging on logical qubits 27, 14, and 44.

Merged logical qubit 20 may be generated by performing Z-boundary merging on logical qubits 28, 15, and 45.

The processes of FIG. 17 and FIG. 18 may be performed in parallel.

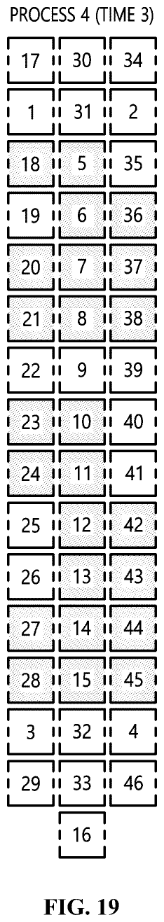

Referring to FIG. 19, each of merged logical qubits 11 to 20 may be split into logical qubits having the original size by the Z-boundary split operation performed thereon.

Referring to FIG. 20, merged logical qubits 21 to 22 may be initialized to the |+>_{L} state.

Merged logical qubit 21 is a single logical qubit having a size that includes all of logical qubits 1 and 18 to 28, and may generate the |+>_{L} state by performing a |+>_{L} initialization process of the logical qubit.

Merged logical qubit 22 may generate the |+>_{L} state by performing the same process as merged logical qubit 21.

Merged logical qubit 22 is a single logical qubit including logical qubits 2 and 35 to 45.

The method of selecting the logical qubits constituting the merged logical qubits in FIG. 20 is the same method as described in FIG. 4.

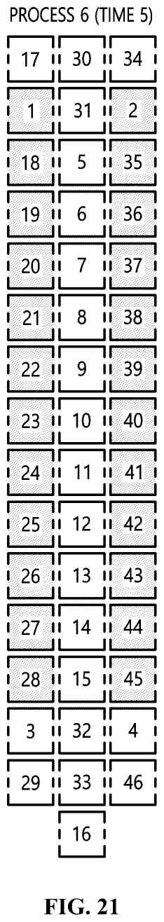

Referring to FIG. 21, each of merged logical qubits 21 to 22 may be split into logical qubits having the original size by the X-boundary split operation performed thereon.

Merged logical qubit 21 may be split into logical qubits 1 and 18 to 28 by X-boundary splitting performed thereon.

Merged logical qubit 22 may be split into logical qubits 2 and 35 to 45 by X-boundary splitting performed thereon.

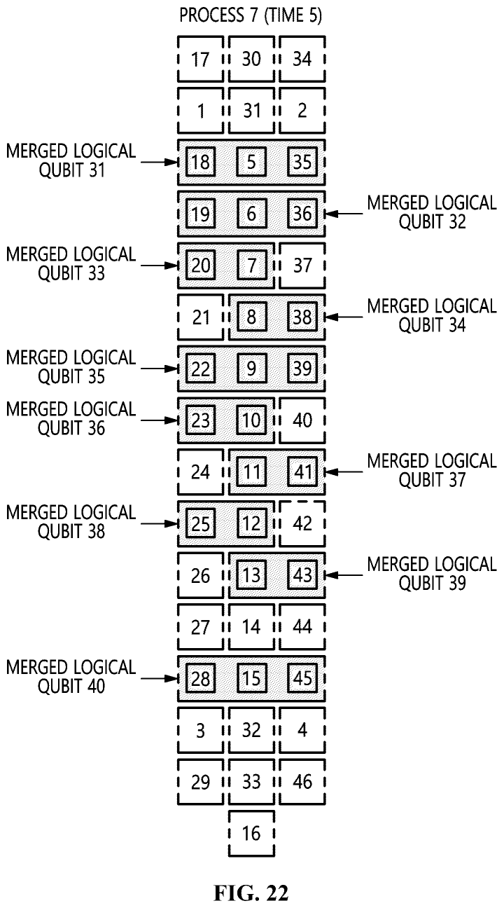

Referring to FIG. 22, it can be seen that merged logical qubits 31 to 40 are generated by performing a Z-boundary merge operation. The method of selecting the logical qubits constituting the merged logical qubits in FIG. 22 is the same method as that described in FIG. 6.

Merged logical qubit 31 may be generated by performing Z-boundary merging on logical qubits 18, 5, and 35.

Merged logical qubit 32 may be generated by performing Z-boundary merging on logical qubits 19, 6, and 36.

Merged logical qubit 33 may be generated by performing Z-boundary merging on logical qubits 20 and 7.

Merged logical qubit 34 may be generated by performing Z-boundary merging on logical qubits 8 and 38.

Merged logical qubit 35 may be generated by performing Z-boundary merging on logical qubits 22, 9, and 39.

Merged logical qubit 36 may be generated by performing Z-boundary merging on logical qubits 23 and 10.

Merged logical qubit 37 may be generated by performing Z-boundary merging on logical qubits 11 and 41.

Merged logical qubit 38 may be generated by performing Z-boundary merging on logical qubits 25 and 12.

Merged logical qubit 39 may be generated by performing Z-boundary merging on logical qubits 13 and 43.

Merged logical qubit 40 may be generated by performing Z-boundary merging on logical qubits 28, 15, and 45.

The processes of FIG. 21 and FIG. 22 may be performed in parallel.

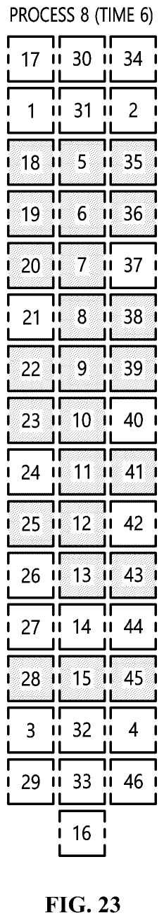

Referring to FIG. 23, each of merged logical qubits 31 to 40 may be split into logical qubits having the original size by the Z-boundary split operation performed thereon.

Referring to FIG. 24, it can be seen that 15 ancilla logical qubits having a |A>_{LH} state and 15 ancilla logical qubits having a |Y>_{LH} state are generated through state injection in order to perform the T_{L}⁺ operations in code block 3 of FIG. 2.

The |A>_{LH} state and the |Y>_{LH} state are the states of an undistilled logical qubit with a high error rate.

In the process of injecting 15 |A>_{LH} states, state injection into logical qubits 31, 18, 35, 28, 32, and 45 may be performed while maintaining the X and Z boundaries of the logical qubits.

Here, state injection into logical qubits 19, 37, 21, 39, 23, 41, 25, 43, and 27 may be performed in the form of a 90-degree rotation of the X and Z boundaries of the logical qubits.

In the process of injecting 15 |Y>_{LH} states, state injection into logical qubits 17, 30, 34, 29, 33, and 46 may be performed while maintaining the X and Z boundaries of the logical qubits.

Here, state injection into logical qubits 36, 20, 38, 22, 40, 24, 42, 26, and 44 may be performed in the form of a 90-degree rotation of the X and Z boundaries of the logical qubits.

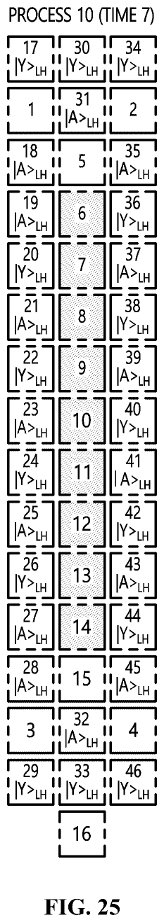

Referring to FIG. 25, the X and Z boundaries of logical qubits 6 to 14 may be rotated by 90 degrees.

The reason why it is necessary to rotate the logical qubits by 90 degrees in FIG. 24 and FIG. 25 is the same as that described in FIGS. 12 and 13. Ancilla logical qubits 19 to 27 and 36 to 44 and data logical qubits 6 to 14 correspond to the logical qubits required to be rotated by 90 degrees.

The processes of FIG. 24 and FIG. 25 may be performed in parallel.

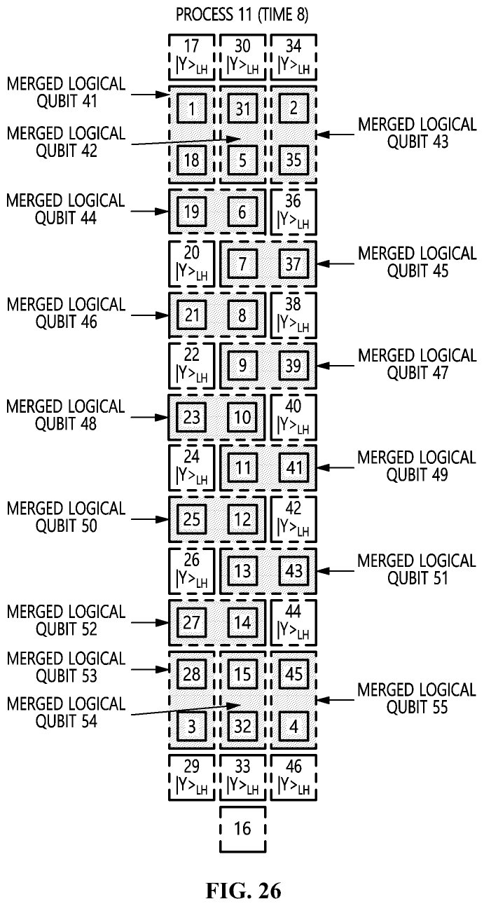

Referring to FIG. 26, it can be seen that merged logical qubits 41 to 55 are generated by performing X-boundary merging of logical qubits 1 to 15 with adjacent logical qubits having a |A>_{LH} state.

Merged logical qubit 41 may be generated by performing X-boundary merging on logical qubits 1 and 18.

Merged logical qubit 42 may be generated by performing X-boundary merging on logical qubits 31 and 5.

Merged logical qubit 43 may be generated by performing X-boundary merging on logical qubits 2 and 35.

Merged logical qubit 44 may be generated by performing X-boundary merging on logical qubits 19 and 6.

Merged logical qubit 45 may be generated by performing X-boundary merging on logical qubits 7 and 37.

Merged logical qubit 46 may be generated by performing X-boundary merging on logical qubits 21 and 8.

Merged logical qubit 47 may be generated by performing X-boundary merging on logical qubits 9 and 39.

Merged logical qubit 48 may be generated by performing X-boundary merging on logical qubits 23 and 10.

Merged logical qubit 49 may be generated by performing X-boundary merging on logical qubits 11 and 41.

Merged logical qubit 50 may be generated by performing X-boundary merging on logical qubits 25 and 12.

Merged logical qubit 51 may be generated by performing X-boundary merging on logical qubits 13 and 43.

Merged logical qubit 52 may be generated by performing X-boundary merging on logical qubits 27 and 14.

Merged logical qubit 53 may be generated by performing X-boundary merging on logical qubits 28 and 3.

Merged logical qubit 54 may be generated by performing X-boundary merging on logical qubits 15 and 32.

Merged logical qubit 55 may be generated by performing X-boundary merging on logical qubits 45 and 4.

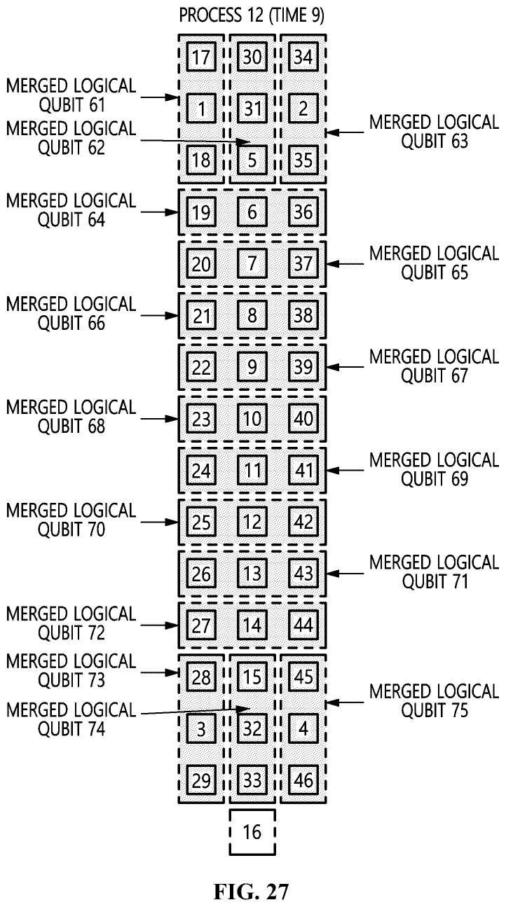

Referring to FIG. 27, it can be seen that merged logical qubits 41 to 55, generated by the process of FIG. 26, are expanded into merged logical qubits 61 to 75 by performing X-boundary merging with the adjacent logical qubits having the |Y>_{LH} state.

The process of FIG. 27 may be performed selectively for each merged logical qubit depending on the result of performing the process of FIG. 26.

When the process of FIG. 26 is performed, a joint measurement value may be obtained for each merged logical qubit.

When the joint measurement value of a specific merged logical qubit is −1, the corresponding merged logical qubit may be expanded through the process of FIG. 27.

If the eigenvalue of the joint measurement value is +1, the corresponding merged logical qubit is not expanded.

For example, if the joint measurement value of merged logical qubit 42 is −1, merged logical qubit 42 may be expanded into merged logical qubit 62.

Merged logical qubit 61 may be expanded to include logical qubit 17 if the joint measurement value of merged logical qubit 41 is −1.

Merged logical qubit 62 may be expanded to include logical qubit 30 if the joint measurement value of merged logical qubit 42 is −1.

Merged logical qubit 63 may be expanded to include logical qubit 34 if the joint measurement value of merged logical qubit 43 is −1.

Merged logical qubit 64 may be expanded to include logical qubit 36 if the joint measurement value of merged logical qubit 44 is −1.

Merged logical qubit 65 may be expanded to include logical qubit 20 if the joint measurement value of merged logical qubit 45 is −1.

Merged logical qubit 66 may be expanded to include logical qubit 38 if the joint measurement value of merged logical qubit 46 is −1.

Merged logical qubit 67 may be expanded to include logical qubit 22 if the joint measurement value of merged logical qubit 47 is −1.

Merged logical qubit 68 may be expanded to include logical qubit 40 if the joint measurement value of merged logical qubit 48 is −1.

Merged logical qubit 69 may be expanded to include logical qubit 24 if the joint measurement value of merged logical qubit 49 is −1.

Merged logical qubit 70 may be expanded to include logical qubit 42 if the joint measurement value of merged logical qubit 50 is −1.

Merged logical qubit 71 may be expanded to include logical qubit 26 if the joint measurement value of merged logical qubit 51 is −1.

Merged logical qubit 72 may be expanded to include logical qubit 44 if the joint measurement value of merged logical qubit 52 is −1.

Merged logical qubit 73 may be expanded to include logical qubit 29 if the joint measurement value of merged logical qubit 53 is −1.

Merged logical qubit 74 may be expanded to include logical qubit 33 if the joint measurement value of merged logical qubit 54 is −1.

Merged logical qubit 75 may be expanded to include logical qubit 46 if the joint measurement value of merged logical qubit 55 is −1.

Finally, when merged logical qubits 61 to 75 are measured in the X-basis, a distilled |A>_{L1} state may be generated in logical qubit 16.

In FIGS. 16 to 27, there are 12 execution processes, and these processes may be executed in chronological order. Here, processes 2 and 3 of FIG. 17 and FIG. 18 are performed in parallel. Similarly, processes 6 and 7 of FIG. 21 and FIG. 22 are performed in parallel, and processes 9 and 10 of FIG. 24 and FIG. 25 may also be performed in parallel.

When the time required for error syndrome measurement is defined as one unit of time, one unit of time may be used for each process. Therefore, the time taken to execute the magic state |A>_{L1} distillation circuit may be 9.

When the processes of FIGS. 4 to 14 and FIGS. 16 to 27 are performed, the first distilled magic states |Y>_{L1} and |A>_{L1} may be obtained.

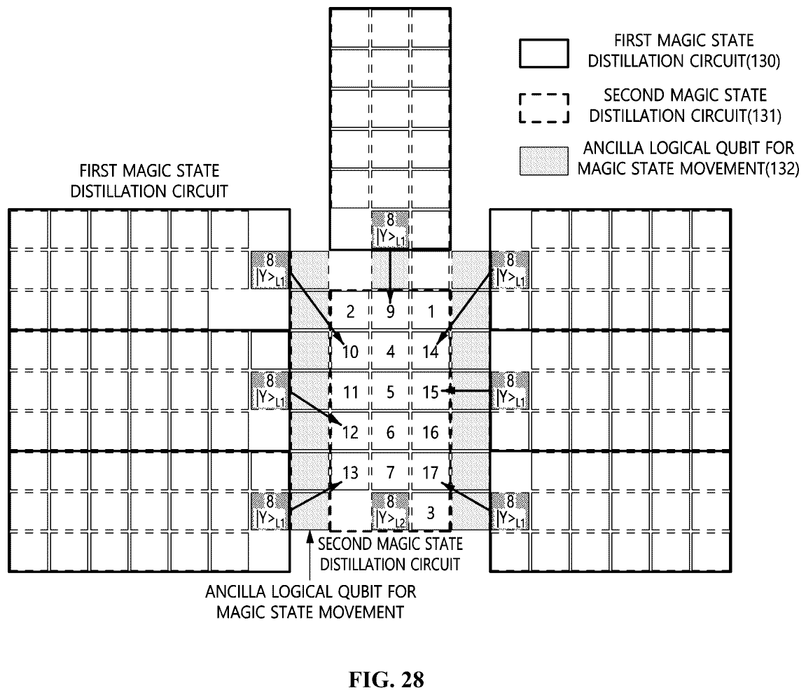

FIG. 28 is a view illustrating the logical qubit layout of a second magic state |Y>_{L2} distillation circuit for generating a magic state |Y>_{L2} by further performing second distillation on first distilled |Y>_{L1} according to an embodiment of the present disclosure.

Referring to FIG. 28, it can be seen that the second magic state |Y>_{L2} distillation circuit is configured with seven first magic state |Y>_{L1} distillation circuits 130 and a single second magic state |Y>_{L2} distillation circuit 131.

At the first step, seven first distilled magic states |Y>_{L1} may be generated by executing the seven first magic state |Y>_{L1} distillation circuits 130, and may then be stored in respective logical qubits 8 of the seven first magic state |Y>_{L1} distillation circuits. The first step may be performed in the same manner as the process described with reference to FIGS. 4 to 14.

At the second step, a second distilled magic state |Y>_{L2} may be generated by executing the second magic state |Y>_{L2} distillation circuit 131. The second step may be performed in the same manner as the process described with reference to FIGS. 4 to 14. However, at the second step, |Y>_{L1} may be used instead of |Y>_{LH}.

It can be seen that the |Y>_{LH} state is generated through state injection in FIG. 12, but the second magic state distillation circuit uses the first distilled magic state |Y>_{L1} rather than |Y>_{LH}. The seven |Y>_{L1} states stored in the first magic state |Y>_{L1} distillation circuits 130 may be moved to the second magic state |Y>_{L2} distillation circuit 131 using ancilla logical qubits for magic state movement (132). When execution of the second magic state |Y>_{L2} distillation circuits 131 is finished, a second distilled magic qubit |Y>_{L2} may be generated in logical qubit 8 of the second magic state |Y>_{L2} distillation circuit 131.

That is, the second magic state |Y>_{L2} distillation circuit injects the magic states |Y>_{L1} corresponding to the distilled magic qubit |Y>_{L} from the first magic state |Y>_{L1} distillation circuits into seven ancilla logical qubits of the second magic state |Y>_{L2} distillation circuit for outputting a second distilled magic qubit |Y>_{L2}, thereby outputting the second distilled magic qubit |Y>_{L2}.

Here, it can be seen that the logical qubit layout of the second magic state |Y>_{L2} distillation circuit is configured such that the output data logical qubits of the seven logical qubit layouts corresponding to the seven first magic state |Y>_{L1} distillation circuits are connected with the seven ancilla logical qubits of the second magic state |Y>_{L2} distillation circuit.

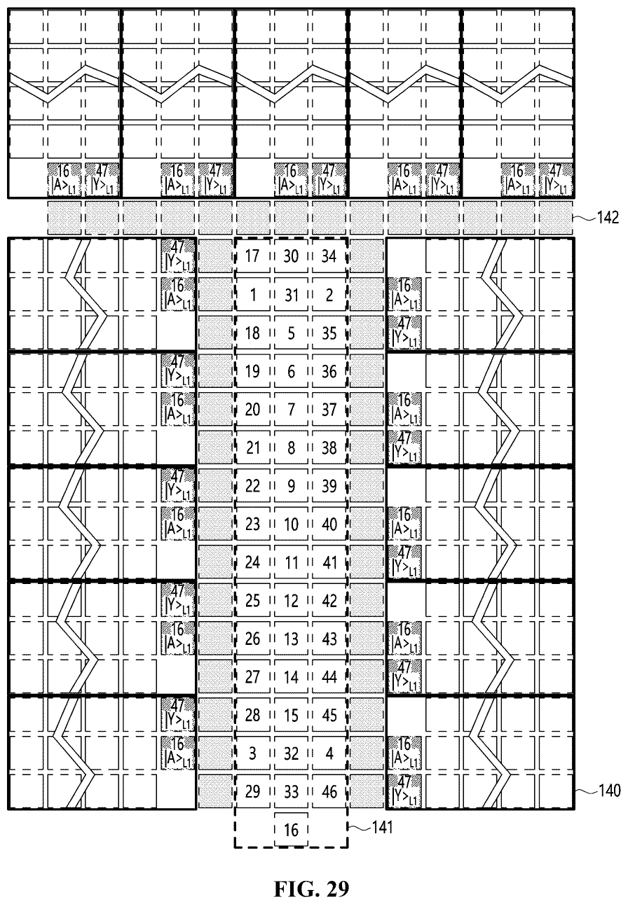

FIG. 29 is view illustrating the logical qubit layout of a second magic state |A>_{L2} distillation circuit for generating a magic state |A>_{L2} by further performing second distillation on first distilled |A>_{L1} according to an embodiment of the present disclosure.

Referring to FIG. 29, it can be seen that the logical qubit layout is configured with 15 first magic state |A>_{L1} distillation circuits 140 and a single second magic state |A>_{L2} distillation circuit 141. In FIG. 29, the 15 first magic state |A>_{L1} distillation circuits 140 are briefly represented using a wave pattern.

The second magic state distillation circuit 141 for |A>_{L2} requires two types of first distilled magic states |A>_{L1} and |Y>_{L1}. Accordingly, the 15 first magic state |A>_{L1} distillation circuits 140 may generate |A>_{L1} and |Y>_{L1}. To this end, one logical qubit (the qubit number 47) is added to each of the first magic state |A>_{L1} distillation circuits 140 in FIG. 29, compared to FIGS. 16 to 27.

The second magic state |A>_{L2} distillation circuit 141 may generate a second distilled magic state |A>_{L2}. The second magic state |A>_{L2} distillation circuit 141 may be executed in the same manner as the execution method of FIGS. 16 to 27. However, the second magic state |A>_{L2} distillation circuit 141 uses |A>_{L1} and |Y>_{L1} rather than |A>_{LH} and |Y>_{LH}. In FIG. 24, it can be seen that |A>_{LH} and |Y>_{LH} states are generated through state injection. It can be seen that the second magic state |A>_{L2} distillation circuit 141 uses |A>_{L1} and |Y>_{L1}, which are the first distilled magic states, instead of |A>_{LH} and |Y>_{LH}. The 15 |A>_{L1} states and the 15 |Y>_{L1} states stored in the first magic state |A>_{L1} distillation circuits 140 may be moved to the second magic state |A>_{L2} distillation circuit 141 using ancilla logical qubits for magic state movement (142). When execution of the second magic state |A>_{L2} distillation circuit 141 is finished, a second distilled magic qubit |A>_{L2} may be generated in logical qubit 16.

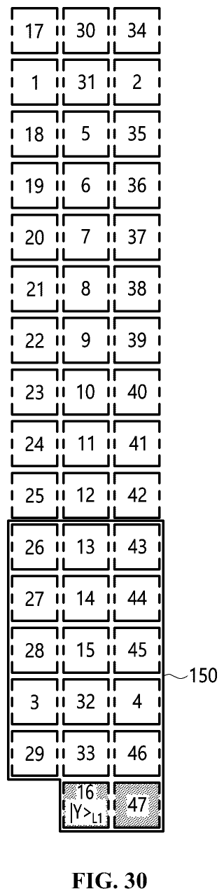

The detailed structure and operation thereof will be described with reference to FIGS. 30 to 32.

FIGS. 30 to 32 are views illustrating in detail an example of a process of distilling a magic state |A>_{L2} using the logical qubit layout diagram of the second magic state distillation circuit illustrated in FIG. 29.

Referring to FIG. 30, a similar first magic state |Y>_{L1} distillation circuit is formed using only the marked logical qubits 150 in the first magic state |A>_{L1} distillation circuit 140, whereby |Y>_{L1} may be generated in logical qubit 16 through the processes of FIGS. 4 to 14.

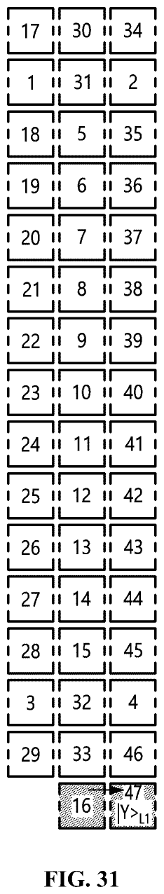

Referring to FIG. 31, the first magic state |A>_{L1} distillation circuit 140 may move |Y>_{L1} stored in logical qubit 16 to logical qubit 47.

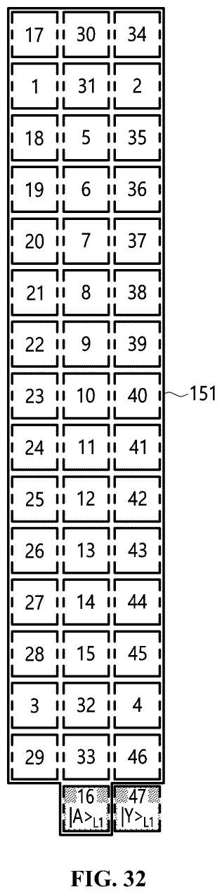

Referring to FIG. 32, the first magic state |A>_{L1} distillation circuit 140 may generate |A>_{L1} in logical qubit 16 using the marked logical qubits 151 by performing the processes of FIGS. 16 to 27.

That is, the second magic state |A>_{L2} distillation circuit injects the first magic states |A>_{L1}, corresponding to the distilled magic qubit |A>_{L}, and the first magic states |Y>_{L1} from the 15 first magic state |A>_{L1} distillation circuits, which output the distilled magic qubit |A>_{L}, into the 30 ancilla logical qubits of the second magic state |A>_{L2} distillation circuit for outputting a second distilled magic qubit |A>_{L2}, thereby outputting the second distilled magic state |A>_{L2}.

Here, the second magic state |A>_{L2} distillation circuit selects the output data logical qubit and 16 logical qubits closest to the output data logical qubit in the first magic state |A>_{L1} distillation circuit, thereby executing the similar first magic state |Y>_{L1} distillation circuit for generating the first magic state |Y>_{L1}.

Here, the second magic state |A>_{L2} distillation circuit moves the magic state |Y>_{L1} generated in the output data logical qubit of the similar first magic state |Y>_{L1} distillation circuit to an adjacent logical qubit, thereby configuring the adjacent logical qubit as the magic state |Y>_{L1} output data logical qubit.

It can be seen that the logical qubit layout of the second magic state |A>_{L2} distillation circuit is configured such that the first magic state |A>_{L1} output data logical qubits and the first magic state |Y>_{L1} output data logical qubits of the 15 logical qubit layouts, corresponding to the 15 first magic state |A>_{L1} distillation circuits, are connected with the 30 ancilla logical qubits of the second magic state |A>_{L2} distillation circuit.

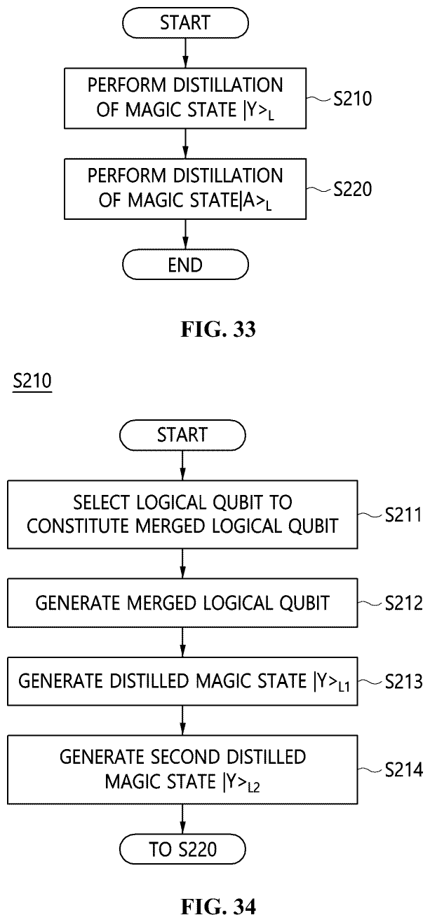

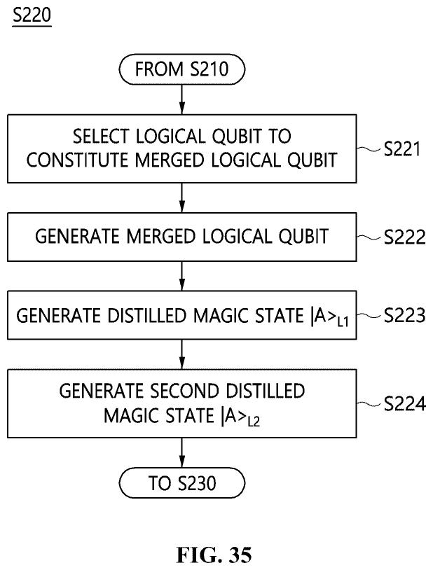

FIG. 33 is a flowchart illustrating a method for executing a magic state distillation circuit in a logical qubit quantum system according to an embodiment of the present disclosure. FIG. 34 is a flowchart illustrating an example of the step of performing distillation of a magic state |Y>_{L} illustrated in FIG. 33. FIG. 35 is a flowchart illustrating an example of the step of performing distillation of a magic state |A>_{L} illustrated in FIG. 33.

Referring to FIG. 33, in the method for executing a magic state distillation circuit in a logical qubit quantum system according to an embodiment of the present disclosure, first, distillation of a magic state |Y>_{L} may be performed at S210.

That is, at step S210, a magic state |Y>_{L} distillation circuit in which a plurality of multi-target CNOT operations are performed in parallel is executed, whereby a distilled magic state |Y>_{L} may be output.

Here, the magic state |Y>_{L} distillation circuit is configured with three code blocks, code blocks 1 and 2 may be configured with a plurality of multi-target CNOT operations, and code block 3 may be configured with S_{L} operations and measurement operations.

Here, eight data logical qubits may be used in the magic state |Y>_{L} distillation circuit, and three of the eight data logical data qubits may be used as control data logical qubits of the multi-target CNOT operations, four of the eight data logical qubits may be used as target data logical qubits of the multi-target CNOT operations, and one of the eight data logical qubits may be used as an output data logical qubit for outputting a distilled magic qubit |Y>_{L}.

Here, the logical qubit layout corresponding to the magic state |Y>_{L}, distillation circuit may be configured such that the eight data logical qubits are arranged and nine ancilla logical qubits are additionally arranged using lattice surgery in order to connect the eight data logical qubits.

Here, the three control data logical qubits, among the data logical qubits, may be arranged one by one at the outer edges of the logical qubit layout, the four target data logical qubits, among the data logical qubits, may be arranged in the center of the logical qubit layout, and the ancilla logical qubits may be arranged to connect the control data logical qubits with the target data logical qubits.

Referring to FIG. 34, at step S210, the logical qubits to constitute merged logical qubits may be selected at step S211.

That is, at step S211, the logical qubits to constitute merged logical qubits may be selected in the logical qubit layout corresponding to the magic state |Y>_{L} distillation circuit.

Also, at step S210, merged logical qubits may be generated at step S212.

That is, at step S212, the operation of generating a merged logical qubit and the operation of splitting the generated merged logical qubit are repeated, after which a magic state |Y>_{LH} may be injected into seven ancilla logical qubits.

Here, at step S212, seven merged logical qubits are generated by merging the seven ancilla logical qubits into which the magic state |Y>_{LH} is injected with adjacent data logical qubits.

Also, at step S210, a distilled magic state |Y>_{L1} may be generated at step S213.

That is, at step S213, the seven merged logical qubits are measured in the X-basis, whereby a distilled magic qubit |Y>_{L1} may be output.

Here, at steps S211 to S213, the operation process described with reference to FIGS. 4 to 14 may be performed.

Also, at step S210, a second distilled magic state |Y>_{L2} may be generated at step S214.

That is, at step S214, the magic state |Y>_{L1} corresponding to the distilled magic qubit |Y>_{L} is injected from the seven first magic state |Y>_{L1} distillation circuits, which output the distilled magic qubit |Y>_{L}, into seven ancilla logical qubits of a second magic state |Y>_{L2} distillation circuit for outputting a second distilled magic qubit |Y>_{L2}, whereby the second distilled magic qubit |Y>_{L2} may be output.

Here, at step S214, the operation process described with reference to FIG. 28 may be performed.

Here, the logical qubit layout of the second magic state |Y>_{L2} distillation circuit may be configured such that the output data logical qubits of the seven logical qubit layouts corresponding to the seven first magic state |Y>_{L1} distillation circuits are connected with the seven ancilla logical qubits of the second magic state |Y>_{L2} distillation circuit.

Also, in the method for executing a magic state distillation circuit in a logical qubit quantum system according to an embodiment of the present disclosure, distillation of a magic state |A>_{L} may be performed at step S220.

That is, at step S220, a magic state |A>_{L} distillation circuit in which a plurality of multi-target CNOT operations are performed in parallel is executed, whereby a distilled magic state |A>_{L} may be output.

Here, the magic state |A>_{L} distillation circuit is configured with three code blocks, code blocks 1 and 2 may be configured with a plurality of multi-target CNOT operations, and code block 3 may be configured with T_{L}⁺ operations and measurement operations.

Here, 16 data logical qubits may be used in the magic state |A>_{L} distillation circuit, four of the 16 data logical qubits may be used as control data logical qubits of the multi-target CNOT operations, 11 of the 16 data logical qubits may be used as target data logical qubits of the multi-target CNOT operations, and one of the 16 data logical qubits may be used as an output data logical qubit for outputting a distilled magic qubit |A>_{L}.

Here, the logical qubit layout corresponding to the magic state |A>_{L} distillation circuit may be configured such that the 16 data logical qubits are arranged and 30 ancilla logical qubits are additionally arranged using lattice surgery in order to connect the 16 data logical qubits.

The four control data logical qubits, among the data logical qubits, may be arranged one by one at the outer edges of the logical qubit layout, the 11 target data logical qubits, among the data logical qubits, may be arranged in the center of the logical qubit layout, and the ancilla logical qubits may be arranged to connect the control data logical qubits with the target data logical qubits.

Here, at least two of the ancilla logical qubits may be connected to the control data logical qubit and the target data logical qubit.

Referring to FIG. 35, at step S220, the logical qubits to constitute merged logical qubits may selected at step S221.

That is, at step S221, the logical qubits to constitute merged logical qubits may be selected in the logical qubit layout corresponding to the magic state |A>_{L} distillation circuit.

Also, at step S220. merged logical qubits may be generated at step S222.

That is, at step S222, the operation of generating a merged logical qubit by selecting the logical qubits to constitute the merged logical qubit in the logical qubit layout corresponding to the magic state |A>_{L} distillation circuit and the operation of splitting the generated merged logical qubit are repeated, a magic state |A>_{LH} may be injected into 15 ancilla logical qubits, and a magic state |Y>_{LH} may be injected into 15 additional ancilla logical qubits.

Here, at step S222, 15 merged logical qubits may be generated by merging the 15 ancilla logical qubits into which the magic state |A>_{LH} is injected with adjacent data logical qubits, and the 15 merged logical qubits may be additionally merged with the 15 adjacent ancilla logical qubits into which the magic state |Y>_{LH} is injected.

Here, at step S222, the joint measurement values of the 15 merged logical qubits are obtained, after which the merged logical qubit may be expanded by being additionally merged with the adjacent logical qubit, into which the magic state |Y>_{LH} is injected, when the joint measurement value thereof is −1. However, the merged logical qubit may not be expanded when the joint measurement value thereof is +1.

Also, at step S220, a distilled magic state |A>_{L1} may be generated at step S223.

That is, at step S223, the 15 expanded merged logical qubits are measured in the X-basis, whereby the distilled magic qubit |A>_{L1} may be output.

Here, at steps S221 to S223, the operation process described with reference to FIGS. 16 to 27 may be performed.

Also, at step S220, a second distilled magic state |A>_{L2} may be generated at step S224.

That is, at step S224, the first magic state |A>_{L1}, corresponding to the distilled magic qubit |A>_{L}, and the first magic state |Y>_{L1} are injected from the 15 first magic state |A>_{L} distillation circuits, which output the distilled magic qubit |A>_{L1}, into 30 ancilla logical qubits of a second magic state |A>_{L2} distillation circuit for outputting a second distilled magic qubit |A>_{L2}, whereby the second distilled magic state |A>_{L2} may be output.

Here, at step S224, the output data logical qubit and 16 logical qubits closest to the output data logical qubit are selected in the first magic state |A>_{L1} distillation circuit, whereby a similar first magic state |Y>_{L1} distillation circuit for generating a first magic state |Y>_{L1} may be executed.

Here, at step S224, the magic state |Y>_{L1} generated in the output data logical qubit of the similar first magic state |Y>_{L1} distillation circuit is moved to an adjacent logical qubit, whereby the adjacent logical qubit may be configured as a magic state |Y>_{L1} output data logical qubit.

Here, the logical qubit layout of the second magic state |A>_{L2} distillation circuit may be configured such that the first magic state |A>_{L1} output data logical qubits and the first magic state |Y>_{L1} output data logical qubits of the 15 logical qubit layouts corresponding to the 15 first magic state |A>_{L1} distillation circuits are connected with the 30 ancilla logical qubits of the second magic state |A>_{L2} distillation circuit.

Here, at step S224, the operation process described with reference to FIGS. 29 to 32 may be performed.

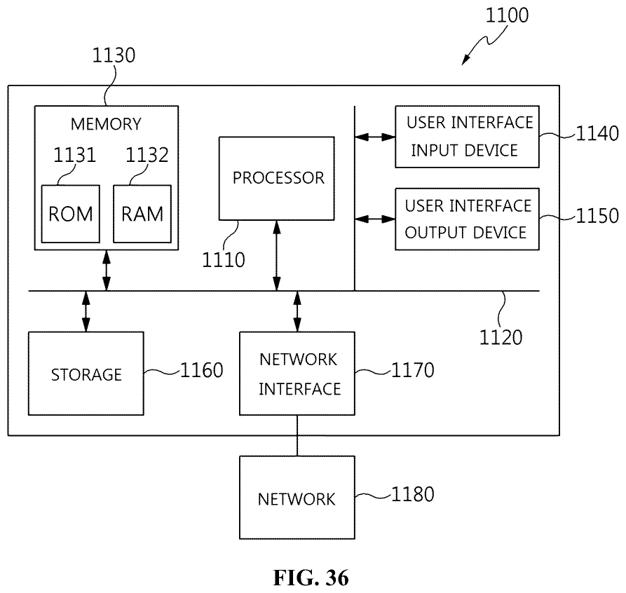

FIG. 36 is a view illustrating a computer system according to an embodiment of the present disclosure.

Referring to FIG. 36, an apparatus for executing a magic state distillation circuit in a logical qubit quantum system according to an embodiment of the present disclosure may be implemented in a computer system 1100 including a computer-readable recording medium. As illustrated in FIG. 36, the computer system 1100 may include one or more processors 1110, memory 1130, a user-interface input device 1140, a user-interface output device 1150, and storage 1160, which communicate with each other via a bus 1120. Also, the computer system 1100 may further include a network interface 1170 connected to a network 1180. The processor 1110 may be a central processing unit or a semiconductor device for executing processing instructions stored in the memory 1130 or the storage 1160. The memory 1130 and the storage 1160 may be any of various types of volatile or nonvolatile storage media. For example, the memory may include ROM 1131 or RAM 1132.

The apparatus for executing a magic state distillation circuit in a logical qubit quantum system according to an embodiment of the present disclosure includes one or more processors 1110 and memory 1130 for storing at least one program executed by the one or more processors 1110, and the at least one program outputs a distilled magic state |Y>_{L} by executing a magic state |Y>_{L} distillation circuit in which a plurality of multi-target CNOT operations are performed in parallel and outputs a distilled magic state |A>_{L} by executing a magic state |A>_{L} distillation circuit in which a plurality of multi-target CNOT operations are performed in parallel. The magic state |Y>_{L} distillation circuit is configured with three code blocks, code blocks 1 and 2 are configured with a plurality of multi-target CNOT operations, and code block 3 is configured with S_{L} operations and measurement operations. The magic state |A>_{L} distillation circuit is configured with three code blocks, code blocks 1 and 2 are configured with a plurality of multi-target CNOT operations, and code block 3 is configured with T_{L}⁺ operations and measurement operations.

Here, eight data logical qubits may be used in the magic state |Y>_{L} distillation circuit, three of the eight data logical qubits may be used as control data logical qubits of the multi-target CNOT operations, four of the eight data logical qubits may be used as target data logical qubits of the multi-target CNOT operations, and one of the eight data logical qubits may be used as an output data logical qubit for outputting a distilled magic qubit |Y>_{L}.

Here, the logical qubit layout corresponding to the magic state |Y>_{L} distillation circuit may be configured such that the eight data logical qubits are arranged and nine ancilla logical qubits are additionally arranged using lattice surgery in order to connect the eight data logical qubits.

Here, the three control data logical qubits, among the data logical qubits, may be arranged one by one at the outer edges of the logical qubit layout, the four target data logical qubits, among the data logical qubits, may be arranged in the center of the logical qubit layout, and the ancilla logical qubits may be arranged to connect the control data logical qubits with the target data logical qubits.

Here, the at least one program may repeat the operation of generating a merged logical qubit by selecting the logical qubits to constitute the merged logical qubit in the logical qubit layout corresponding to the magic state |Y>_{L} distillation circuit and the operation of splitting the generated merged logical qubit, and may then inject a magic state |Y>_{LH} to seven ancilla logical qubits.

Here, the at least one program generates seven merged logical qubits by merging the seven ancilla logical qubits into which the magic state |Y>_{L1} is injected with adjacent data logical qubits and measures the seven merged logical qubits in the X-basis, thereby outputting a distilled magic qubit |Y>_{L}.

Here, the at least one program injects the magic state |Y>_{L1} corresponding to the distilled magic qubit |Y>_{L} from the seven first magic state |Y>_{L1} distillation circuits, which output the distilled magic qubit |Y>_{L}, into seven ancilla logical qubits of a second magic state |Y>_{L2} distillation circuit for outputting a second distilled magic qubit |Y>_{L2}, thereby outputting the second distilled magic qubit |Y>_{L2}.

Here, the logical qubit layout of the second magic state |Y>_{L2} distillation circuit may be configured such that the output data logical qubits of the seven logical qubit layouts corresponding to the seven first magic state |Y>_{L1} distillation circuits are connected with the seven ancilla logical qubits of the second magic state |Y>_{L2} distillation circuit.

Here, 16 data logical qubits may be used in the magic state |A>_{L} distillation circuit, four of the 16 data logical qubits may be used as control data logical qubits of the multi-target CNOT operations, 11 of the 16 data logical qubits may be used as target data logical qubits of the multi-target CNOT operations, and one of the 16 data logical qubits may be used as an output data logical qubit for outputting a distilled magic qubit |A>_{L}.

Here, the logical qubit layout corresponding to the magic state |A>_{L}, distillation circuit may be configured such that the 16 data logical qubits are arranged and 30 ancilla logical qubits are additionally arranged using lattice surgery in order to connect the 16 data logical qubits.

The four control data logical qubits, among the data logical qubits, may be arranged one by one at the outer edges of the logical qubit layout, the 11 target data logical qubits, among the data logical qubits, may be arranged in the center of the logical qubit layout, and the ancilla logical qubits may be arranged to connect the control data logical qubits with the target data logical qubits.

Here, at least two of the ancilla logical qubits may be connected with the control data logical qubit and the target data logical qubit.

Here, the at least one program may repeat the operation of generating a merged logical qubit by selecting the logical qubits to constitute the merged logical qubit in the logical qubit layout corresponding to the magic state |A>_{L} distillation circuit and the operation of splitting the generated merged logical qubit, inject a magic state |A>_{LH} into 15 ancilla logical qubits, and inject a magic state |Y>_{LH} into 15 additional ancilla logical qubits.

Here, the at least one program generates 15 merged logical qubits by merging the 15 ancilla logical qubits into which the magic state |A>_{LH} is injected with adjacent data logical qubits, expands the 15 merged logical qubits by additionally merging the same with the adjacent 15 ancilla logical qubits into which the magic state |Y>_{LH} is injected, and measures the expanded 15 merged logical qubits in the X-basis, thereby outputting a distilled magic qubit |A>_{L}.

Here, the at least one program may obtain the joint measurement values of the 15 merged logical qubits, may expand the merged logical qubit by additionally merging the same with the adjacent logical qubit, into which the magic state |Y>_{LH} is injected, when the joint measurement value thereof is −1, and may not expand the merged logical qubit when the joint measurement value thereof is +1.

Here, the at least one program injects the first magic state |A>_{L1}, corresponding to the distilled magic qubit |A>_{L}, and the first magic state |Y>_{L1} from the 15 first magic state |A>_{L1} distillation circuits, which output the distilled magic qubit |A>_{L}, into 30 ancilla logical qubits of the second magic state |A>_{L2} distillation circuit for outputting a second distilled magic qubit |A>_{L2}, thereby outputting the second distilled magic state |A>_{L2}.

Here, the at least one program selects an output data logical qubit and 16 logical qubits closest to the output data logical qubit in the first magic state |A>_{L1} distillation circuit, thereby executing a similar first magic state |Y>_{L1} distillation circuit for generating a first magic state |Y>_{L1}.

Here, the at least one program moves the magic state |Y>_{L1} generated in the output data logical qubit of the similar first magic state |Y>_{L1} distillation circuit to an adjacent logical qubit, thereby configuring the adjacent logical qubit as a magic state |Y>_{L1} output data logical qubit.

Here, the logical qubit layout of the second magic state |A>_{L2} distillation circuit may be configured such that the first magic state |A>_{L1} output data logical qubits and the first magic state |Y>_{L1} output data logical qubits of the 15 logical qubit layouts, corresponding to the 15 first magic state |A>_{L1} distillation circuits, are connected with the 30 ancilla logical qubits of the second magic state |A>_{L2} distillation circuit.

The present disclosure may reduce the time required to execute an operation included in a magic state distillation circuit.

Also, the present disclosure may reduce the number of logical qubits required for an operation included in a magic state distillation circuit.

As described above, the apparatus and method for executing a magic state distillation circuit in a logical qubit quantum system according to the present disclosure are not limitedly applied to the configurations and operations of the above-described embodiments, but all or some of the embodiments may be selectively combined and configured, so the embodiments may be modified in various ways.

What is claimed is:

1. An apparatus for executing a magic state distillation circuit in a logical qubit quantum system, comprising:
one or more processors; and
memory for storing at least one program executed by the one or more processors,
wherein:
the at least one program outputs a distilled magic state |Y>_{L} by executing a magic state |Y>_{L} distillation circuit in which a plurality of multi-target CNOT operations are performed in parallel and outputs a distilled magic state |A>_{L} by executing a magic state |A>_{L} distillation circuit in which a plurality of multi-target CNOT operations are performed in parallel,
the magic state |Y>_{L} distillation circuit is configured with three code blocks, code blocks 1 and 2 being configured with a plurality of multi-target CNOT operations and code block 3 being configured with S_{L} operations and measurement operations, and
the magic state |A>_{L} distillation circuit is configured with three code blocks, code blocks 1 and 2 being configured with a plurality of multi-target CNOT operations and code block 3 being configured with T_{L}⁺ operations and measurement operations.

2. The apparatus of claim 1, wherein
eight data logical qubits are used in the magic state |Y>_{L} distillation circuit,
three of the eight data logical qubits are used as control data logical qubits of the multi-target CNOT operations,
four of the eight data logical qubits are used as target data logical qubits of the multi-target CNOT operations, and
one of the eight data logical qubits is used as an output data logical qubit for outputting a distilled magic qubit |Y>_{L}.

3. The apparatus of claim 2, wherein a logical qubit layout corresponding to the magic state |Y>_{L} distillation circuit is configured such that the eight data logical qubits are arranged and nine ancilla logical qubits are additionally arranged using lattice surgery in order to connect the eight data logical qubits.

4. The apparatus of claim 3, wherein
the three control data logical qubits, among the data logical qubits, are arranged one by one at outer edges of the logical qubit layout,
the four target data logical qubits, among the data logical qubits, are arranged in a center of the logical qubit layout, and
the ancilla logical qubits are arranged to connect the control data logical qubits with the target data logical qubits.

5. The apparatus of claim 1, wherein the at least one program repeats an operation of generating a merged logical qubit by selecting logical qubits to constitute the merged logical qubit in a logical qubit layout corresponding to the magic state |Y>_{L} distillation circuit and an operation of splitting the generated merged logical qubit and then injects a magic state |Y>_{LH} into seven ancilla logical qubits.

6. The apparatus of claim 5, wherein the at least one program generates seven merged logical qubits by merging the seven ancilla logical qubits into which the magic state |Y>_{LH} is injected with adjacent data logical qubits and measures the seven merged logical qubits in an X-basis, thereby outputting a distilled magic qubit |Y>_{L}.

7. The apparatus of claim 6, wherein the at least one program injects a magic state |Y>_{L1}, corresponding to the distilled magic qubit |Y>_{L}, from seven first magic state |Y>_{L1} distillation circuits, which output the distilled magic qubit |Y>_{L}, into seven ancilla logical qubits of a second magic state |Y>_{L2} distillation circuit for outputting a second distilled magic qubit |Y>_{L2}, thereby outputting the second distilled magic qubit |Y>_{L2}.

8. The apparatus of claim 7, wherein a logical qubit layout of the second magic state |Y>_{L2} distillation circuit is configured such that output data logical qubits of seven logical qubit layouts corresponding to the seven first magic state |Y>_{L1} distillation circuits are connected with the seven ancilla logical qubits of the second magic state |Y>_{L2} distillation circuit.

9. The apparatus of claim 1, wherein
16 data logical qubits are used in the magic state |A>_{L} distillation circuit,
four of the 16 data logical qubits are used as control data logical qubits of the multi-target CNOT operations,
11 of the 16 data logical qubits are used as target data logical qubits of the multi-target CNOT operations, and
one of the 16 data logical qubits is used as an output data logical qubit for outputting a distilled magic qubit |A>_{L}.

10. The apparatus of claim 9, wherein a logical qubit layout corresponding to the magic state |A>_{L} distillation circuit is configured such that the 16 data logical qubits are arranged and 30 ancilla logical qubits are additionally arranged using lattice surgery in order to connect the 16 data logical qubits.

11. The apparatus of claim 10, wherein
the four control data logical qubits, among the data logical qubits, are arranged one by one at outer edges of the logical qubit layout,
the 11 target data logical qubits, among the data logical qubits, are arranged in a center of the logical qubit layout, and
the ancilla logical qubits are arranged to connect the control data logical qubits with the target data logical qubits.

12. The apparatus of claim 11, wherein at least two of the ancilla logical qubits are connected with the control data logical qubit and the target data logical qubit.

13. The apparatus of claim 1, wherein the at least one program repeats an operation of generating a merged logical qubit by selecting logical qubits to constitute the merged logical qubit in a logical qubit layout corresponding to the magic state |A>_{L} distillation circuit and an operation of splitting the generated merged logical qubit, injects a magic state |A>_{LH} into 15 ancilla logical qubits, and injects a magic state |Y>_{LH} into 15 additional ancilla logical qubits.

14. The apparatus of claim 13, wherein the at least one program generates 15 merged logical qubits by merging the 15 ancilla logical qubits into which the magic state |A>_{LH} is injected with adjacent data logical qubits, expands the 15 merged logical qubits by additionally merging the 15 merged logical qubits with the adjacent 15 ancilla logical qubits into which the magic state |Y>_{LH} is injected, and measures the expanded 15 merged logical qubits in an X-basis, thereby outputting a distilled magic qubit |A>_{L}.

15. The apparatus of claim 14, wherein the at least one program obtains joint measurement values of the 15 merged logical qubits, expands the merged logical qubit by additionally merging the merged logical qubit with the adjacent logical qubit, into which the magic-state |Y>_{LH} is injected, when the joint measurement value of the merged logical qubit is −1, and does not expand the merged logical qubit when the joint measurement value of the merged logical qubit is +1.

16. The apparatus of claim 14, wherein the at least one program injects a first magic state |A>_{L1}, corresponding to the distilled magic qubit |A>_{L}, and a first magic state |Y>_{L1} from 15 first magic state |A>_{L1} distillation circuits, which output the distilled magic qubit |A>_{L}, into 30 ancilla logical qubits of a second magic state |A>_{L2} distillation circuit for outputting a second distilled magic qubit |A>_{L2}, thereby outputting a second distilled magic state |A>_{L2}.

17. The apparatus of claim 16, wherein the at least one program selects an output data logical qubit in the first magic state |A>_{L1} distillation circuit and 16 logical qubits closest to the output data logical qubit, thereby executing a similar first magic state |Y>_{L1} distillation circuit for generating the first magic state |Y>_{L1}.

18. The apparatus of claim 17, wherein the at least one program moves the magic state |Y>_{L1} generated in an output data logical qubit of the similar first magic state |Y>_{L1} distillation circuit to an adjacent logical qubit, thereby configuring the adjacent logical qubit as a magic state |Y>_{L1} output data logical qubit.

19. The apparatus of claim 18, wherein a logical qubit layout of the second magic state |A>_{L2} distillation circuit is configured such that first magic state |A>_{L1} output data logical qubits and first magic state |Y>_{L1} output data logical qubits of 15 logical qubit layouts corresponding to the 15 first magic state |A>_{L1} distillation circuits are connected with the 30 ancilla logical qubits of the second magic state |A>_{L2} distillation circuit.

20. A method for executing a magic state distillation circuit in a logical qubit quantum system, performed by an apparatus for executing the magic state distillation circuit in the logical qubit quantum system, comprising:
outputting a distilled magic state |Y>_{L} by executing a magic state |Y>_{L} distillation circuit in which a plurality of multi-target CNOT operations are performed in parallel; and
outputting a distilled magic state |A>_{L} by executing a magic state |A>_{L} distillation circuit in which a plurality of multi-target CNOT operations are performed in parallel,
wherein
the magic state |Y>_{L} distillation circuit is configured with three code blocks, code blocks 1 and 2 being configured with a plurality of multi-target CNOT operations and code block 3 being configured with S_{L} operations and measurement operations, and
the magic state |A>_{L} distillation circuit is configured with three code blocks, code blocks 1 and 2 being configured with a plurality of multi-target CNOT operations and code block 3 being configured with T_{L}⁺ operations and measurement operations.
